(19) United States
(12) Patent Application Publication
(10) Pub. No.: US 2013/0085798 A1
(43) Pub. Date: Apr. 4, 2013

(54) SYSTEMS AND METHODS FOR IMPLEMENTING MEDICAL WORKFLOW

(71) Applicants: Brian Spatola, Huntington Beach, CA (US); Roman Wicha, Henderson, NV (US); Matthew Adler, Kildeer, IL (US); Shridhar Parvatikar, Fremont, CA (US); Ravi Bilwa, Fremont, CA (US); Paul Yokoyama, Henderson, NV (US); Ross Bernard Hannibal, Saratoga, CA (US)

(72) Inventors: Brian Spatola, Huntington Beach, CA (US); Roman Wicha, Henderson, NV (US); Matthew Adler, Kildeer, IL (US); Shridhar Parvatikar, Fremont, CA (US); Ravi Bilwa, Fremont, CA (US); Paul Yokoyama, Henderson, NV (US); Ross Bernard Hannibal, Saratoga, CA (US)

(73) Assignee: VARIAN MEDICAL SYSTEMS, INC., Palo Alto, CA (US)

(21) Appl. No.: 13/251,133

(22) Filed: Sep. 30, 2011

(51) Int. Cl. G06Q 10/06

(52) U.S. Cl. 705/7.24; 705/7.12

(57) ABSTRACT

A method for use in a medical process includes providing a plurality of task objects for selection by a user, wherein the plurality of task objects represent respective tasks, determining a first one of the plurality of task objects, determining a second one of the plurality of task objects, linking the first one of the plurality of task objects with the second one of the plurality of task objects using a processor based at least in part on a command by the user, and storing data in a non-transitory medium regarding the linking.

### FIELD

This application relates generally to systems and methods for implementing medical workflow.

### BACKGROUND

Radiation therapy has been employed to treat tumorous tissue. In radiation therapy, a high energy beam is applied from an external source towards the patient. The external source, which may be rotating (as in the case for arc therapy), produces a collimated beam of radiation that is directed into the patient to the target site. The dose and placement of the dose must be accurately controlled to ensure that the tumor receives sufficient radiation, and that damage to the surrounding healthy tissue is minimized.

Implementation of a radiation therapy involves many different tasks performed by different professionals, including doctors, nurses, technicians, treatment planner, etc. By means of non-limiting examples, such tasks may include consultation by a doctor, verification of insurance by a nurse, obtaining imaging (e.g., CT imaging, x-ray, MRI, PET, SPECT, etc.) by a technician, processing of images by another technician, contouring of organ structures by a doctor/technician, treatment planning by a doctor/technician, treatment preparation by nurse(s) and/or technician(s), treatment execution by a doctor/technician, follow-up by a doctor, and pain management by a nurse/doctor, etc.

The different tasks associated with a radiation therapy may be performed at different locations in different facilities, and may be required to be performed by certain due dates before another task may begin. Sometimes, if a person fails to perform a task, others may be unable to perform their tasks because the performance of their tasks may depend from a result of an earlier task. Also, different facilities that are involved in implementing a radiation therapy may not have access to a same information.

Applicant of the subject application determines that it would be desirable to provide a new system and method to manage persons involved in a radiation therapy so that tasks involved in the radiation therapy are performed in an orderly manner while reducing risks of delay. Applicant of the subject application also determines that it would be desirable to provide a new system and method for allowing different users from different departments to access the same information for a radiation therapy.

### SUMMARY

In accordance with some embodiments, a method for use in a medical process includes providing a plurality of task objects for selection by a user, wherein the plurality of task objects represent respective tasks, determining a first one of the plurality of task objects, determining a second one of the plurality of task objects, linking the first one of the plurality of task objects with the second one of the plurality of task objects using a processor based at least in part on a command by the user, and storing data in a non-transitory medium regarding the linking.

In accordance with other embodiments, a computer product includes a non-transitory medium for storing a set of instructions, an execution of which causes a process to be performed, the process comprising providing a plurality of task objects for selection by a user, wherein the plurality of task objects represent respective tasks, determining a first one of the plurality of task objects, determining a second one of the plurality of task objects, and linking the first one of the plurality of task objects with the second one of the plurality of task objects based at least in part on a command by the user.

In accordance with other embodiments, a system for use in a medical process includes a processor configured for providing a plurality of task objects for selection by a user, wherein the plurality of task objects represent respective tasks, determining a first one of the plurality of task objects, determining a second one of the plurality of task objects, and linking the first one of the plurality of task objects with the second one of the plurality of task objects based at least in part on a command by the user.

Other and further aspects and features will be evident from reading the following detailed description of the embodiments.

### BRIEF DESCRIPTION OF THE DRAWINGS

The drawings illustrate the design and utility of embodiments, in which similar elements are referred to by common reference numerals. These drawings are not necessarily drawn to scale. In order to better appreciate how the above-recited and other advantages and objects are obtained, a more particular description of the embodiments will be rendered, which are illustrated in the accompanying drawings. These drawings depict only typical embodiments and are not therefore to be considered limiting of its scope.

FIG. 1 illustrates a user interface for implementing a medical workflow in accordance with some embodiments;

FIGS. 2A-2D illustrate different devices for implementing a medical workflow in accordance with different embodiments;

FIG. 3 illustrates a window for allowing a user to view information that are associated with task object(s) in accordance with some embodiments;

FIG. 4 illustrates a window for allowing a user to view information that are associated with task object(s) in accordance with other embodiments;

FIG. 5 illustrates a window for allowing a user to view patient information and tasks in accordance with some embodiments;

FIG. 6 illustrates a window for allowing a user to view consolidated notes in accordance with some embodiments;

FIG. 7A illustrates a variation of a workflow diagram in accordance with other embodiments;

FIG. 7B illustrates a configuration window for allowing users to configure a patient summary in accordance with some embodiments;

FIG. 8 illustrates a window for providing multiple sections for different respective workspaces in accordance with some embodiments;

FIG. 9A illustrates a workspace configured for allowing users to prescribe written directives for delivering radiotherapy in accordance with some embodiments;

FIG. 9B illustrates another workspace configured for allowing users to prescribe written directives for delivering radiotherapy in accordance with other embodiments;

FIG. 10 illustrates a system for implementing embodiments of a user interface in accordance with some embodiments; and

FIG. 11 is a block diagram of a computer system architecture, with which embodiments described herein may be implemented.

### DESCRIPTION OF THE EMBODIMENTS

Various embodiments are described hereinafter with reference to the figures. It should be noted that the figures are not drawn to scale and that elements of similar structures or functions are represented by like reference numerals throughout the figures. It should also be noted that the figures are only intended to facilitate the description of the embodiments. They are not intended as an exhaustive description of the invention or as a limitation on the scope of the invention. In addition, an illustrated embodiment needs not have all the aspects or advantages shown. An aspect or an advantage described in conjunction with a particular embodiment is not necessarily limited to that embodiment and can be practiced in any other embodiments even if not so illustrated.

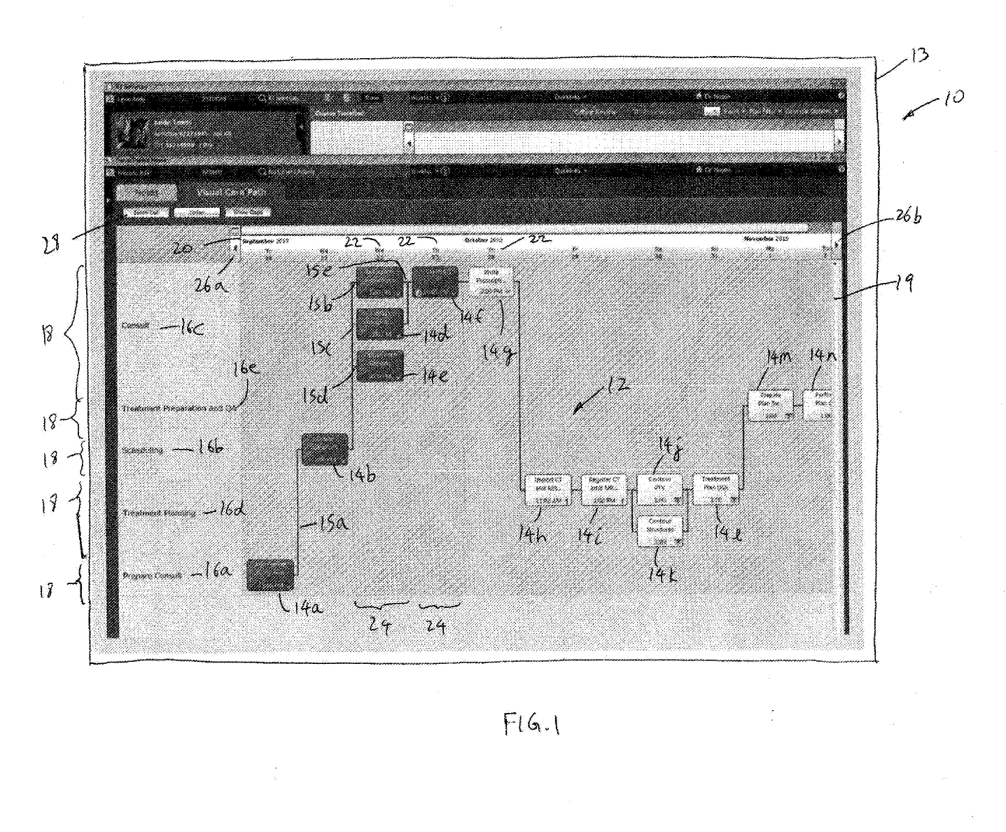

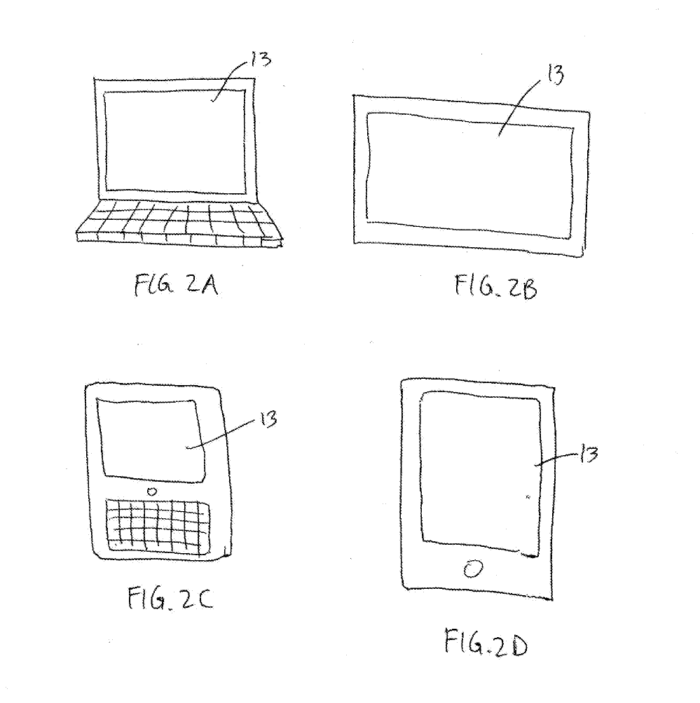

FIG. 1 illustrates a user interface 10 for implementing a medical workflow in accordance with some embodiments. As used in this specification, the term “user interface” may refer to any graphics configured to display information to a user, and/or any device for providing such graphics, wherein such graphics may be displayed in a screen or may be stored in a non-transitory medium as data. The user interface 10 includes a chart 12 displayed in a screen 13, wherein the chart 12 has a plurality of task objects 14 that are coupled through links 15. In some embodiments, the screen 13 for displaying the user interface 10 may be a part of a computer (e.g., a desktop, laptop, etc.) (FIG. 2A). In other embodiments, the screen 13 may be a part of a hand-held communication device, such as a tablet (e.g., an iPad, Android pad, Nook, reading pad, etc.) (FIG. 2B), an emailing device (e.g., a Blackberry) (FIG. 2C), or a phone (e.g., iPhone) (FIG. 2D). Returning to FIG. 1, the chart 12 represents a workflow, wherein each task object 14 represents a task (or procedure) that is to be performed by one or more persons in the workflow. As shown in the figure, the chart 12 includes different task categories 16 into which the at least one task objects 14 may be organized 16. For example, as shown in the illustrated embodiments, the task object 14a “Add patient to system” belongs to task category 16a “Prepare consult”, and the task object 14b “Define carepath” belongs to task category 16b “Scheduling”. Similarly, the task objects 14c-14g belongs to task category 16c “Consult”, the task objects 14h-14l belongs to task category 16d “Treatment planning”, the task objects 14m-14n belong to task category 16e “Treatment preparation and quality assurance”, and so forth. The task objects 14h-14l represents tasks that are involved in a treatment planning process, wherein clinicians identify the target region (e.g., tumor) and critical organs from a three-dimensional image (e.g., CT image) of the patient, manually segment the tumor (to receive a prescribed dose of radiation) and critical organs that are at risk of damage from the radiation treatment, and create a treatment plan using an optimization technique based on the segmentation of the tumor and critical organs.

In the chart 12, the task categories 16 are organized into rows 18, wherein any task object 14 in any one of the rows 18 belongs to the task category 16 for that row 18. In other embodiments, the task categories 16 may be arranged in columns, or in other configurations. The user interface 10 also includes a scroll bar 19 for allowing a user to scroll up and down to access different portions of the chart 12. The user interface 10 also includes scroll buttons 26a, 26b for allowing a user to scroll left and right to access different portions of the chart 12. Also, in other embodiments, the screen 13 may be a touch screen, in which cases, the screen 13 itself may be used to scroll through the chart 12 (e.g., by placing a finger on the screen 13, and dragging the finger to the up, down, left, or right, to scroll to up, down, left, or right, respectively, of the chart 12).

As shown in the illustrated embodiments, the user interface 10 also includes a calendar 20 with different dates 22 arrange in different respective columns, and different task objects 14 may be placed in different date columns 24. In the illustrated example, the task objects 14c-14e are all located in the date column “Oct. 22, 2010”, indicating that these tasks are to be completed by that date. In other embodiments, the dates 22 may be arranged in rows, or in other configurations. The buttons 26a, 26b are configured for allowing a user to scroll to the left or right, respectively, of the calendar 20. In other embodiments, the screen 13 may be a touch screen, in which cases, the screen 13 itself may be used to scroll through the calendar 20 (e.g., by placing a finger on the screen 13, and drag the finger to the left or right to scroll to the left or right, respectively, of the calendar 20).

The user interface 10 may also include a zoom button for allowing a user to zoom in or to zoom out of the calendar 20 so that the user may see more or less task objects 14 on the screen 13. In other embodiments, the screen 13 may be a touch screen, in which cases, the screen 13 itself may be used to zoom in or out of the calendar 20 (e.g., by placing two fingers on the screen 13, and spreading them apart while touching the screen 13 to zoom in, or bringing them together while touching the screen 13 to zoom out).

In the illustrated embodiments, each link 15 in the chart 12 connects a task object 14 to the rest of the workflow. For example the link 15a indicates that task of the task object 14b is to be performed after the task of the task object 14a is completed. The links 15b-15d indicate that the tasks of the task objects 14c-14e may be performed in parallel after the task of the task object 14b is completed. Also, link 15e indicates that the task of the task object 14f is to be completed after both the tasks of the task objects 14d, 14e are completed. As shown in the illustrated embodiments, any link 15 on one side (e.g., the left side) of the task object 14 indicates that there is another task that needs to be performed before the task of the task object 14 may be completed, and any link 15 on another side (e.g., the right side) of the task object 14 indicates that there is another task to be completed after the task of the task object 14 is completed. A task object 14 may have a link 15 on its left side, on its right side, on both the left and right sides, or may have no link 15.

Various techniques may be employed to create the chart 12. In some embodiments, the user interface 10 allows different charts 12 to be created for different respective patients. A user who wishes to create a chart 12 for a particular patient, may open a new chart 12 and save it under a specific name for the patient. Once the new chart 12 is opened, the user interface 10 may provide a number of the task objects 14 for a user to choose from. For example, the interface 10 may provide a pull-down menu or a folder that includes all available task objects 14 so that the user can choose one-by-one (e.g., by clicking the object in the pull-down menu or folder), and place the task objects 14 into different dates in the chart 12 area (e.g., by dragging the selected object to the calendar area) to create a workflow. After a task object 14 is placed into the chart 12, the user interface 10 may allow the user to move the task object 14 (e.g., to a different date column 24), or to delete the task object 14.

In other embodiments, the user interface 10 may provide the different task categories 16 into which the task objects 14 are organized for allowing the user to choose from while creating the chart 12. For example, the user interface 10 may provide a tab or a pull-down menu for the “Consult” category 16c. In such cases, when the user select the “Consult category 16c”, the user interface 10 automatically provides all of the available task objects 14 that belong to the selected “Consult category 16c.” The user interface 10 may also provide other tabs for the other task categories 16.

After a task object 14 is placed into the chart 12, the user creating the chart 12 may add a link 15 to connect the object 14 to the rest of the workflow. In some embodiments, the user interface 10 provides a linking tool that allows the user to create the link 15 between two objects 14. In some embodiments, the linking tool may be a line-drawing tool. In other embodiments, the linking tool may allow the user to click on two objects 14 to connect.

Although the chart 12 has been described as being created by a user, in other embodiments, the chart 12 may be created by multiple users. For example, in some embodiments, a first user may input a few task objects 14 to create a part of a workflow, and another user may input additional task object(s) 14 for other part(s) of the workflow. In one implementation, the created chart 12 may be stored in a database, and one or more users may access the created chart 12 from the database (e.g., to collaboratively build the chart 12, to edit the chart 12, and/or to simply view the chart 12). In some embodiments, access control may be implemented so that only one user is allowed to make changes to the chart 12 at a time. For example, when one user is accessing the chart 12 from the database, if another user wishes to access the same chart 12, the database may be configured to allow the first user to make changes to the chart 12, and disallow the later user from making changes to the chart (e.g., at least until the first user has logged out from the database). Also, in some embodiments, different users may be assigned with different privileges for accessing the chart 12 from the database. For example, in some embodiments, a user may have a privilege to make changes to the chart 12, while another user may have a privilege to only view, and not to make any change to, the chart 12. In one implementation, when a user logs onto the database, the database will ask the user for a password. Once the user is verified based on the password, the database will allow the user to access the chart 12 (e.g., to make changes, to view, or both, etc.) based on the assigned privilege associated with the particular user. Also, in some embodiments, a plurality of tasks (2 or more) may be included together/serially, so they may be stored as a chain of tasks by default.

In the above embodiments, the workflow chart 12 is created by a user who manually selects the task objects 14, and links them together using links 15. In other embodiments, the linking of the task objects 14 may be performed automatically by the user interface 10. In such cases, after the user selects certain task objects 14, the user interface 10 then automatically links the selected task objects 14 based on certain pre-determined rule(s). For example, if the user selects “treatment plan” object 14 and “insurance verification” object 14, then the user interface 10 may automatically place the “insurance verification” object 14 before the “treatment plan” object 14 in terms of the timing of event, and may then automatically link them together to create the workflow chart 12 by inserting a link 15 between the two objects 14. Users may have the option to modify the created workflow chart 12, such as to add object(s) 14 to the workflow, remove object(s) 14 from the workflow, change the ordering of the objects 14, add link(s) 15, remove link(s), etc.

In further embodiments, the workflow chart 12 may be created automatically. In such cases, the user interface 10 may provide a plurality of workflow templates for users to select. For example, there may be a template for radiation treatment. In such cases, when the user selects the “radiation treatment” workflow template, the user interface 10 will automatically create a workflow 12. In one example, the workflow 12 that is automatically created for the radiation treatment template may include task objects 14 for insurance verification, obtaining imaging, contouring PTV, contouring structure, treatment plan determination, treatment plan verification, patient setup, radiation treatment procedure, and dose evaluation. After the workflow chart 12 is automatically created, users may have the option to modify the workflow chart 12, such as to add object(s) 14 to the workflow, remove object(s) 14 from the workflow, change the ordering of the objects 14, add link(s) 15, remove link(s), etc.

As discussed, each available task object 14 represents a task to be performed. In the illustrated embodiments, a task object 14 may be associated with a workspace. As used in this specification, a workspace refers to any tool that is configured to allow a user to complete a portion or an entirety of a task. In some embodiments, such tool may include a user interface displayed on a screen and implemented using a software and/or hardware (e.g., a processor). In some embodiments, one or more of the workspaces may be provided by the user interface 10. It should be noted that not all of the task objects 14 are associated with respective workspaces, and that a task object 14 may not have any workspace associated thereto. The following is an example of a list of the available task objects 14 for allowing a user to choose from when creating the chart 12 in accordance with some embodiments, wherein the left column include names of the task objects 14, and the right column indicates respective functionalities provided by a workspace for performing the corresponding tasks for the respective task objects 14.

TABLE 1

| Procedure Item Label | Functionalities of workspaces |
|---|---|
| Atlas based segmentation | Navigates users to Smart Segmentation Knowledge Based |
| | Contouring. Allows automatic segmentation of structures |
| Define target | Navigates users to Eclipse contouring tools. Allows manual |
| | drawing of the target, automatic expansion and some |
| | additional operations with structures. |
| Define plan | Allows user to define new plan, add and position fields, |
| | define all fields parameters. Linked to Eclipse External |
| | beam Planning-Field Setup workspace. |
| Calculate plan | Allows user to invoke plan calculation. Also editing of plan |
| | parameters is available. Linked to Eclipse External beam |
| | Planning-Field Setup workspace. |
| Define organs (structures) | Starts a workspace with contouring tools, allows manual |
| | and automatic definition of structures. Tools for adding |
| | margins and Boolean operations with structures are |
| | available. Linked to Eclipse Contouring workspace. |
| Register images-rigid registration | Launches a workspace allowing to perform rigid |
| | registration either manually or automatically. Provides |
| | tools for image registration verification. |
| Review positioning images | Allows users to view acquired images for positioning. |
| | Navigates users to Offline Review Workspace. |
| Review Portal Dosimetry Results | Allows review of acquired integrated portal images. |
| | Provides pass/fail analysis. Linked to Portal Dosimetry |
| | workspace. |
| Define imaging and positioning | Navigates users to Treatment Preparation workspace, lets |
| parameters for a plan | user to add setup fields, calculate DRRs, allows editing of |
| | plan parameters such as couch values etc. Automatically |
| | validates the plan, provides access to Scheduling. |
| Schedule plan/images | Allows definition of fractionation scheme, selection of |
| | frequency and imaging to be used. Linked to Treatment |
| | Preparation Workspace. |
| Review and approve dose | Allows user to review and/or approve plan (transition to |
| distribution | “planning approved” state. Linked to Eclipse External Beam |
| | Planning Field Setup workspace. |
| Compare plans | Allows side by side plan comparison, dose volume |
| | histogram comparison, plan subtraction. Also plan |
| | approval status changes are supported. Linked to Eclipse |
| | External Beam Plan Evaluation workspace. |
| Treatment approve plan | Navigates users to Treatment Preparation workspace, |
| | allows for validating the plan and changing the plan status |
| | to “treatment approved”. |
| Review RT treatment history | Navigates users to RT Summary workspace. A graphical |
| | representation of treatment history for all modalities. |
| | Display of dose summary, imaging status and selected |
| | trends. Provide access to positioning images and additional |
| | details for external beams. |
| Record manual Treatment | Allows user to record manual treatments. Also provides |
| | access to definition/editing of reference point data. |
| | Navigates users to reference Point Workspace. |
| Perform dose correction | Provides access to treatment history data and allows user |
| | to manually correct delivered doses. Navigates users to RT |
| | Summary workspace. |
| Check patient chart (Chart QA) | Allows users to perform Chart Check between planned |
| | and treated values. Navigates users to Chart QA |
| | Workspace. |
| Edit and review patient diagnosis | Allows users to create, modify, review, and stage patient |
| | diagnoses. Navigates users to Diagnosis workspace. |
| Register patient | Allows users to enter, review and update patient |
| | demographic data. Navigates users to Patient Registration |
| | workspace. |
| Enter demographics | Allows users to view, add, and modify patient |
| | demographic information. Navigates users to Registration |
| | Workspace. |
| Enter/verify insurance | Allows users to enter, edit, review insurance information. |
| | Navigates the user to the registration area where they can |
| | access insurance details |
| Enter/edit medical history | Allows users to enter, view, edit, and approve historical |
| | information regarding patient health. Navigates users to |
| | Patient History workspace. |
| Enter/edit patient evaluation | Allows users to view, add, and edit RoS, physical exam, |
| data | toxicities, performance status, questionnaires, tests, vital |
| | signs, chief complaint/HPI, and impression/plan. Navigates |
| | users to Evaluation Workspace |
| Schedule activity/resources | Allows users to view, add, and edit appointments and |
| | tasks. Navigates users to Time Planner Workspace. |
| Define/edit Care Path for a patient | Allows definition and editing of the Care Path using either |
| | Visual Care Path or list-based Care Path. Also allows user |
| | to attach Care Path template(s) to the patient. Navigates |
| | users to the Care Path workspace. |
| Enter and review reference points | Allows user to review and edit reference point data. User |
| | can modify dose contributions, dose coefficients and |
| | define total dose limits. Navigates users to reference Point |
| | Workspace. |
| Review vitals | Allows users to add, view, modify, and approve Vital Signs. |
| | Navigates users to Vital Signs Workspace. |
| Prescribe treatment | Allows users to create, view, edit RT Prescription |
| | information. Navigates users to RT Prescription |
| | Workspace. |
| Define brachytherapy plan | Navigates users to Brachytherapy Planning workspace to |
| | allow for creation, editing and review of Brachy plans |
| Calculate brachytherapy plan | Navigates users to Brachytherapy Planning workspace to |
| | allow for creation, editing and review of Brachy plans |
| Sum and subtract plans | Allows user to sum and subtract plans. Navigates users to |
| | Eclipse External Beam Plan Evaluation workspace. |
| Review plans | Allows user to review, compare and evaluate plans. |
| | Provides DVH display for single or multiple plans. |
| | Navigates users to Eclipse External Beam Plan Evaluation |
| | workspace. |
| Localize stereotactic frame | Allows the user to process a patient CT image series |
| | containing a head ring and a localizer box. Navigates users |
| | to Eclipse SRS Localization workspace. |
| Define cone plan | Allows user to define a new cone plan, add and position |
| | fields, define all field parameters. Navigates users to |
| | Eclipse Cone Planning. |
| Calculate dose for cone plan | Allows user to invoke cone plan calculation. Also editing of |
| | plan parameters is available. Navigates users to Eclipse |
| | Cone Planning. |
| Review dose distribution-cone | Allows user to review a cone plan. Provides DVH display |
| planning | for a calculated cone plan. Navigates users to Eclipse Cone |
| | Planning. |
| Import images | Allows users to import/export DICOM supported objects. |
| | Navigates users to DICOM Import/Export workspace. |
| Import treatment records | Allows users to import/export DICOM supported objects. |
| | Navigates users to DICOM Import/Export Workspace. |
| Run report | Allows users to view, modify, and run a report. Navigates |
| | users to Report Manager Workspace. |
| Import plan | Allows users to import/export DICOM supported objects. |
| | Navigates users to DICOM Import/Export Workspace. |
| Export images | Allows users to import/export DICOM supported objects. |
| | Navigates users to DICOM Import/Export Workspace. |
| Export treatment records | Allows users to import/export DICOM supported objects. |
| | Navigates users to DICOM Import/Export Workspace. |
| Export plan | Allows users to import/export DICOM supported objects. |
| | Navigates users to DICOM Import/Export Workspace. |
| Review/edit charges | Allows users to view, modify, and approve charges for |
| | export. Navigates users to Activity Capture Workspace. |
| Approve charges | Allows users to view, modify, and approve charges for |
| | export. Navigates users to Activity Capture Workspace. |
| View archive data | Allows users to view archived patient data |
| Review test results | Allows users to order lab tests and view lab results. |
| | Navigates users to Test Workspace. |
| Create/edit document | Allows users to create, edit, view, and approve |
| | Documents. Navigates users to Dynamic Documents |
| | Workspace. |
| Create/edit dynamic document | Allows users to create, edit, and view documents for |
| | patient records. Navigates users to documents workspace. |
| Review/approve document | Allows users to create, edit, view, and approve documents. |
| | Navigates users to documents Workspace. |
| Perform simulation | Navigates user Acuity Simulation and allows user to |
| | perform activities related to plan simulation. |
| Acquire simulation CBCT | Allows Cone Beam CT acquisition on Acuity. |
| Perform virtual simulation | Allows user to place fields on 3D data set, calculated DRRs |
| | and perform virtual simulation. Navigates user to External |
| | Beam Planning Field Setup Workspace. |
| Edit 3D plan parameters | Allows definition of the isocenter and plan parameters. |
| | Allows plan dose distribution calculation. Allows access to |
| | plan optimization. Navigates users to Eclipse External |
| | Beam Planning-Field Setup Workspace. |
| Edit 2D plan parameters | Allows definition and edit of 2D plan parameters. |
| | Navigates users to Plan Parameters workspace. May also |
| | be used to edit 3D plans, but not recalculate. |
| Edit brachytherapy plan | Navigates users to Brachytherapy Planning workspace and |
| | allows for creation, editing and review of Brachy plans |
| Optimize brachytherapy plan | Navigates users to Brachytherapy Planning workspace and |
| | allows for creation, editing and review of Brachy plans |
| Review and approve structures | Allows user to review and edit structures and change |
| | structure approval status. Navigates users to Eclipse |
| | Contouring workspace. |
| Review image registration results | Allows user to review and modify results of image |
| | matching (rigid and deformable). Provides tools to change |
| | registration status. Navigates users to SmartAdapt |
| | workspace. |
| Review partial treatment | Allows users to review treatment data from partial and |
| | fully treated histories. Navigates users to RT Summary |
| | Workspace. |
| Browse patient Images | Allows users to access to all images belonging to a patient |
| | for viewing. Navigates users to Image Browser Workspace |
| Import patient demographics | Allows user to import patient information. |
| Review patient journal | Allows users to view, enter, edit, and approve Journal |
| | entries. Navigates users to Journal Workspace. |
| Export patient demographics | Allows users to export Patient treatment records. |
| | Navigates users to DICOM Import/Export Workspace. |
| Complete questionnaire | Allows users to view, add, complete, and approve |
| | questionnaires. Navigates users to Questionnaires |
| | workspace″ |
| Perform consult (physician) | Allows users to view, add, and edit RoS, physical exam, |
| | toxicities, performance status, questionnaires, tests, vital |
| | signs, chief complaint/HPI, and impression/plan. Navigates |
| | users to Evaluation Workspace |
| Order labs/studies | Allows users to create lab/study orders. Navigates users to |
| | Test (Requisitions/Results) Workspace. |
| Review/approve 2D plan | Allows user to review and/or approve 2D plan (transition |
| | to “planning approved” state. Navigates users to Plan |
| | Parameters workspace. May also be used to edit 2D and |
| | 3D plans, and approve 3D plans. |
| Optimize/re-optimize external | Navigates user to Eclipse External Beam planning Setup |
| plan | Workspace and allows to define field parameters and start |
| | optimization process. |
| Review/approve Structures | Navigates users to Eclipse contouring workspace and |
| | allows users to review and approve structures |
| Approve physician order | Allows users to create, modify view and approve physician |
| | orders. Navigates users to Physician order workspace. |
| Transcribe pysician order | Navigates user to Physician Order workspace. Allows users |
| | to create requisitions for order |
| Create physician order | Allows users to create, modify view and approve physician |
| | orders. Navigates users to Physician Order″ workspace. |
| Enter/edit/approve drug order | Allows users create, view, and approve drug orders. |
| | Navigates users to Drug Orders workspace |
| Review activities | Navigates users to Time Planner and allows them to review |
| | activities and schedules. |
| Review referrals | Allows users to create and view referral appointments. |
| | Navigates users to Time Planner workspace. |
| Create office visit summary | Allows users to create, view, and approve office visit |
| | documents. Navigates users to Patient Documents |
| | Workspace. |
| Review current medications | Allows user to enter, view and edit a patient's current |
| | medication information. Navigates users to the Current |
| | Medications workspace. |
| Provide health information to | Allows users to track patient communications regarding |
| patient | health record. Navigates users to Communications |
| | Workspace. |
| Register images-deformable | Allows user to perform deformable image registration and |
| registration | review/modify results of the deformation. Navigates |
| | users to SmartAdapt workspace. |
| Review brachytherapy plans | Navigates users to Brachtheryapy Planning workspace to |
| | allow for creation, editing and review of Brachytherapy |
| | plans. |
| Create brachytherapy | Navigates users to Documents workspace to allow users to |
| documentation | create documentation for Brachy Planning |
| Export to treatment unit | Navigates users to Brachytheray Planning workspace for |
| | the purpose of exporting the plan to the treatment unit. |
| Define Acuity brachytherapy plan | Activity to automatically create a brachytherapy plan from |
| | Acuity. |
| Review patient images and make | Navigates users to Image Browser for the purpose of |
| decision | viewing patient images. |
| Define 3D brachytherapy plan | Navigates users to Brachytherapy Planning Workspace for |
| using existing plan | the purpose of creating a new Brachytherapy plan from |
| | and existing plan. |
| Review and approve | Navigates users to Brachytherapy Planning Workspace to |
| brachytherapy Dose Distribution | allow for approval of Brachytherapy Dose Distributions. |
| Define 2D brachytherapy plan | Navigates user to BrachyVision and allows users to create |
| | a 2D Brachytherapy plan. |
| Weekly chart QA | Allows users to perform weekly chart checks. Navigates |
| | users to Chart QA workspace. |
| Send Reminder | Provide the ability to capture the communication |
| | preference for a patient regarding reminders. |
| Define and Calculate 2D Plan | Navigates user to 2D planning(IRREG) workspace and |
| | allows users to create a 2D plan. |
| Review Editing Log | Navigates user to Editing Log workspace. The Editing Log |
| | displays all relevant actions performance on active plan or |
| | on former plans after treatment has started. |
| RT Patient Position Acquisition | Allows position of patient to be acquired for radiation |
| | treatment. Position acquisition may involve single plane |
| | imaging using MV, dual plane imaging using MV, single |
| | plane imaging using kV, dual plane imaging using kV, dual |
| | plane imaging using kV and MV, imaging using CT in kV, |
| | imaging using CT in MV, imaging using optical device(s), |
| | imaging using ultrasound, or detection of spatial fiducials |
| | (e.g., markers, body landmarks, etc.). |
| RT Patient Position Registration | Allows patient position to be registered for radiation |
| | treatment. |
| RT Treatment Simulation | Performs radiation treatment simulation. |
| RT Treatment | Performs radiation treatment. |

In other embodiments, the list of available task objects 14 may include additional task object(s) not illustrated, or may not include one or more of the task objects 14 illustrated. Also, in some embodiments, the user interface 10 may allow a user to create a new task object 14 and store it in a library so that it becomes one of the available task objects 14 in the list.

Returning to FIG. 1, in some embodiments, the creation of the workflow 12 allows different task objects 14 to be linked, which in turn, links up the different workspaces corresponding to the respective task objects 14 that are needed to complete the workflow 12. In some cases, the different workspaces linked up by the workflow 12 may be different respective softwares that are provided by different companies (or manufacturers) or by the same company. In some embodiments, the system (i.e., the one providing the user interface 10) may be configured to allow a user to launch different workspaces to complete respective tasks that have been assigned to the user based on the workflow 12. In other embodiments, the system may be configured to automatically launch a workspace for a user based on the workflow 12 to allow the user to complete the task assigned to the user.

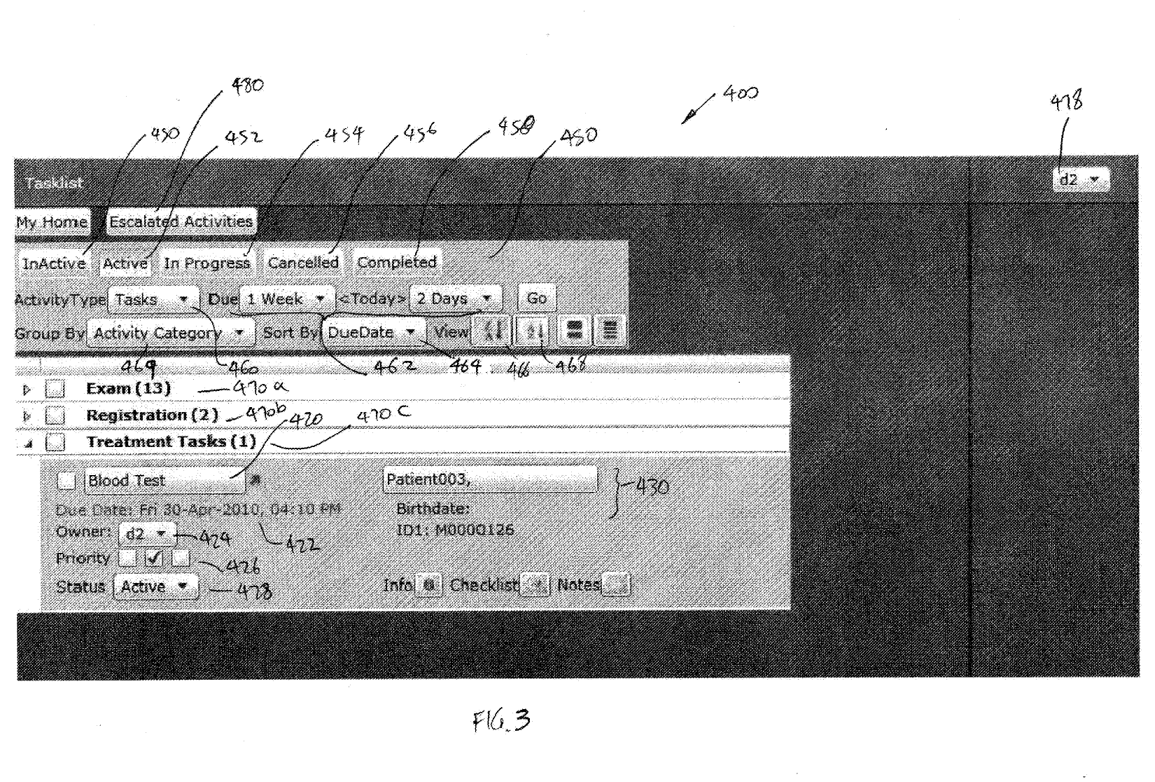

In some embodiments, each task object 14 may have metadata associated therewith. In such cases, when a user selects a certain task object 14 to be included in the workflow, the user may also enter information for the corresponding metadata. Also, in some embodiments, the user interface 10 may provide a window to display the metadata that are associated with the task object 14. As used in this specification, a “window” may be any area in a screen, such as an area defined by a frame, for presenting information. Also, in some embodiments, a window may be provided as a part of a workspace. FIG. 3 illustrates a task window 400 that is configured to display information that is associated with task object(s) 14 in accordance with some embodiments. The task window 400 may include a task description 420, due date 422, owner 424, priority field 426, status 428, and patient information 430. The task description 420 describes the task that is to be performed. The due date 422 indicates the date on which the task is due. The owner 424 indicates the person who is responsible for completing the task 420. The priority field 426 allows a user to assign ranks, or precedence, for activities, and to flag them as such for creating an ordering for the activities. In some embodiments, the interface may also provide an indication of what persons have clearance to do what task. For example, a nurse or technician should not be allowed to modify but can only view the plan, in some embodiments. The status field 428 indicates the status of the task 420 (which may be “active” representing that the task is in progress and/or to be completed, or “inactive” representing that the task is completed). The patient information 430 provides information about the patient, such as patient identification, birth date, etc. In some embodiments, the interface may have an access feature (e.g., requiring password, etc.) to provide restricted access for the patient information. Although one task 420 is shown in the illustrated example for the task object 14, in other embodiments, a task object 14 may include a plurality of tasks.

In the illustrated embodiments, the window 400 also includes a filter tool section 450 that provides different filtering functions. The filter tool section 450 includes an “inactive” button 450 for allowing a user to view only tasks that are inactive (e.g., tasks that have not been started, and cannot be started because a predecessor activity has not been completed), “active” button 452 for allowing a user to view only tasks that are active (e.g., tasks for which a user can act on), “in progress” button 454 for allowing a user to view only tasks that are in progress (e.g., tasks that have been started, but not yet completed), “cancelled” button 456 for allowing a user to view only tasks that are cancelled, and “completed” button 458 for allowing a user to view only tasks that are completed. In some embodiments, if a task has been completed, the user interface may also allow a user to access documents (e.g., from one or more database) that are associated with the completed task. The filter tool section 450 also includes an activity type field 460 for allowing a user to view different types of activity. In the example, “tasks” is shown in the field 460. That means the information would be filtered based on tasks. In other examples, the user may choose “appointments” so that the filtering will be based on appointments. In further examples, the user may choose both “tasks and appointments”, in which case, the filtering will be based on both tasks and appointments. The filter tool section 450 also includes date fields 462 for allowing a user to view tasks that are due within a prescribed period.

The filter tool section 450 also includes a “Sort by” field 464 that allows a user to sort the tasks based on their respective due dates, a “Z-A” sort button 466 for allowing a user to sort the tasks in reverse alphabetical order, and a “A-Z” sort button 468 for allowing a user to sort the tasks in alphabetical order. In some cases, instead of “due dates”, the “Sort by” field 464 may be selectively changed to other parameters, such as patient name, activity name, and activity type, which allows sorting to be performed based on patient name, activity name, and activity type, respectively.

In the illustrated embodiments, the filter tool section 450 also includes a “Group by” field 469 which allows a user to view tasks based on the category (or categories) into which they are grouped. In the illustrated example, “activity category” is selected in the “Group by” field 469, thereby allowing the user to view the tasks based on different activity categories 470a-470c. As shown in the illustrated example, one task is shown under the activity category 470c “Treatment Tasks” when the “Treatment tasks” bar is selected. When the “Exam” bar for the activity category 470a is selected, the user interface 10 may display thirteen (as indicated by the number next to the category name) tasks that are currently grouped under the “Exam” category. Similarly, when the “Registration” bar for the activity category 470b is selected, the user interface 10 may display two (as indicated by the number next to the category name) tasks that are currently grouped under the “Registration” category.

In the illustrated embodiments, the task window 400 also includes an owner selection control 478 for allowing a user to select which owner's tasks he/she wishes to see. In the illustrated example, the owner with identification “d2” has been selected in the owner selection control 478. Thus, all of the tasks being displayed in the task window 400 belong to the owner “d2”.

In the illustrated embodiments, the task window 400 also includes an “Escalated Activities” button 480 for allowing users to manage activity/activities that are overdue. Sometimes, when an activity is overdue, the user interface 10 may be configured (e.g., by a user) to alert another user to “escalate” the task so that the workflow 12 is not interrupted (especially if the user is not available to do the work, such as due to vacation and/or sickness). In the illustrated embodiments, when a certain task associated with a task object 14 is overdue, the user interface 10 may display an escalated button 480 to inform a user (who may be an owner to which the task was assigned to, and/or a person who supervises such owner) that the task has not yet been performed. When the user clicks the escalated button 480, the user interface 10 may inform the user when the task was due, and/or may allow the user to either re-assign the task to another owner, or to do the work himself/herself. Such feature is advantageous because it prevents the patient workflow 12 from being interrupted due to an owner's failure to perform an assigned task (e.g., may be due to the owner is sick or on vacation). This feature allows better management of tasks going on in one or more departments.

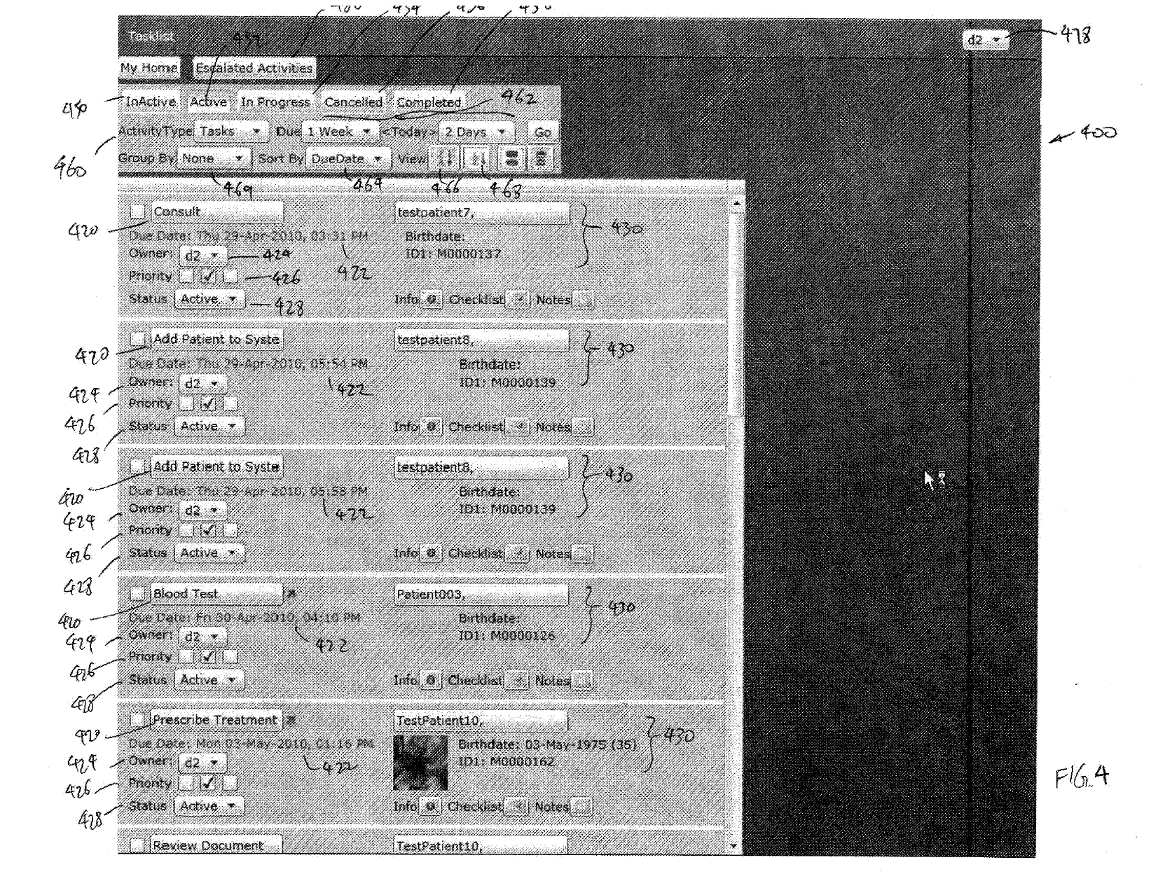

In other embodiments, “None” may be selected in the “Group by” field 469 (FIG. 4), which allows a user to view the tasks regardless of the categories into which they are grouped.

In any of the embodiments described herein, a task object 14 may have a checklist associated therewith. In some embodiments, the checklist may be displayed in a window frame as a part of the user interface 10 in a screen. For example, a “consult” task object 14 representing a consultation task may have a checklist, which includes a number of items, such as (1) check pain, (2) check fever, (3) observe side effect, etc. In such cases, the person who has been assigned the consultation task will need to complete the checklist (e.g., by checking a box), before the task object 14 may be considered to be completed by the user interface 10, thereby allowing the next task object(s) downstream the workflow to be performed. In another example, a checklist that is associated with a task object 14 may relate to a patient safety that is needed during a radiation procedure. For example, such checklist may include items, such as (1) check patient support, (2) check gantry clearance with respect to patient, (3) check radiation source, (4) check patient positioning (e.g., to make sure that target is at isocenter), (5) verify patient is indeed the patient being treated, etc. Also, in some embodiments, a task object 14 may be considered completed if all items in the checklist associated with the task object 14 are completed. The system providing and/or managing the user interface 10 may be configured to monitor task objects 14 that are overdue or about to be overdue. This feature will be described in further detail below.

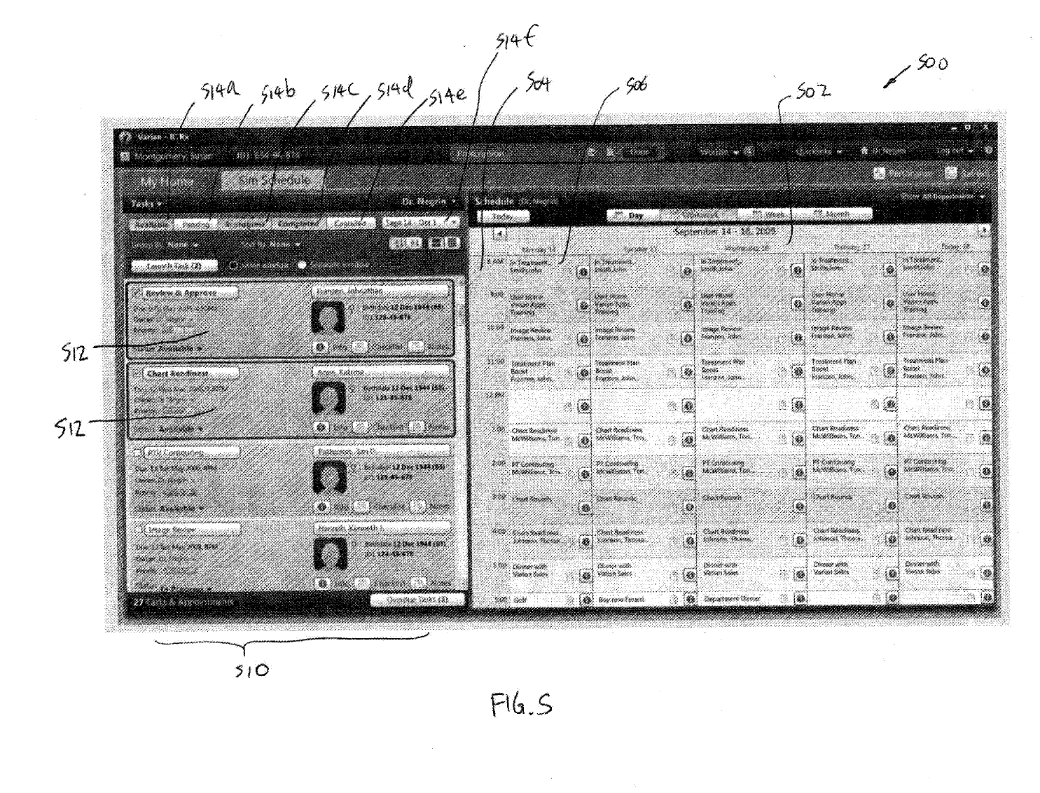

In some embodiments, the user interface 10 may also provide a window 500 for allowing a user to see what activities are due for himself/herself, or for another person (FIG. 5). The window 500 includes a calendar 502 with time slots 504, and activities 506 in the time slots 504. The window 500 also includes a section 510 for displaying patient information 512 for all of the patients for which the user is responsible, and filtering controls 514a-514e for configuring the section 510 to display items that are available, pending, in progress, completed, or cancelled, respectively. The window 500 also includes a date filtering control 514f for allowing a user to view information of patients for which tasks are due within a prescribed date range. In some embodiments, a user may schedule activities using the window 500 (e.g., by inserting data into the calendar 502). Also, in some embodiments, a user may launch single or multiple activities from this screen (e.g. by clicking the activity 506 in the calendar 502). Once the activity 506 is launched, the system (i.e., the one providing the user interface 10) then brings the patient data set and workspace to the user and allows the user to accomplish the activity 506 selected.

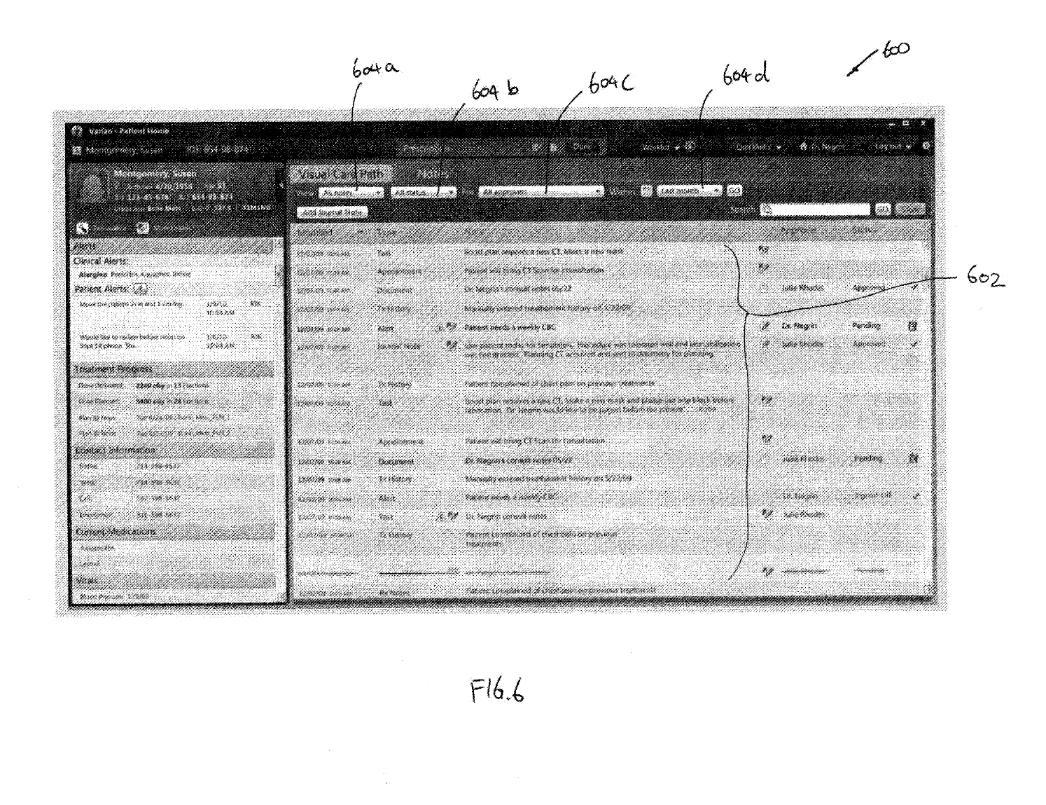

In any of the embodiments described herein, the user interface 10 allows each owner of the task object 14 to make notes for the corresponding task object 14. For example, for a “treatment plan” task object 14, the owner working on the task (e.g., performing radiation treatment planning) for such task object 14 may use the user interface 10 to open up a window or text field, so that the owner can type in the notes and save them in a database. In some cases, different owners for different respective task objects 14 may create and store notes in the database. In some embodiments, the user interface 10 also provides a consolidated note feature that allows a user to view all notes based on certain criteria, such as all notes for a certain patient, all notes created by a certain owner, all notes in a selected one of a plurality of categories (such as task category, treatment history category, alert category), etc. FIG. 6 illustrates an example of a window 600 provided by the user interface 10 that allows a user to view consolidated notes 602 based on certain filtering 604a-604d. The filtering button 604a allows the user to selectively view notes under one or all of the note categories. In the illustrated example, “all notes” is selected, and accordingly, the user interface 10 displays notes from all categories, including the “Document” category (notes created for document), “Task” category (notes created for a certain task), “Appointment” category (notes created for appointment), “Tx History” category (notes created during the course of radiation treatment), “Alert” category (notes created to alert others), and “Journal note” category (journal type notes). The filtering button 604b allows the user to selectively view notes based on the status of a task (e.g., task that is completed, on-going, or to be performed). The filtering button 604c allows the user to selectively view notes based on approver(s). Certain task for a task object 14 may need to be approved by a designated person (approver). In such cases, the notes entered for such task object 14 may need to be reviewed and approved by the approver (wherein in some embodiments, the approval may be tied to the checklist/safety checklist). In some embodiments, the next task object 14 downstream in the workflow 12 is not allowed to be performed until the approver approved the current task object 14. The filtering button 604d allows the user to selectively view notes based on certain date or date range. For example, if the user selects date range from Jan. 3, 2010 to Apr. 4, 2011, then all notes within such date range will be displayed in the window 600. In some embodiments, in addition to filtering, users may sort and/or search for specific notes, as well as add certain types of notes, in this workspace provided by the window 600.

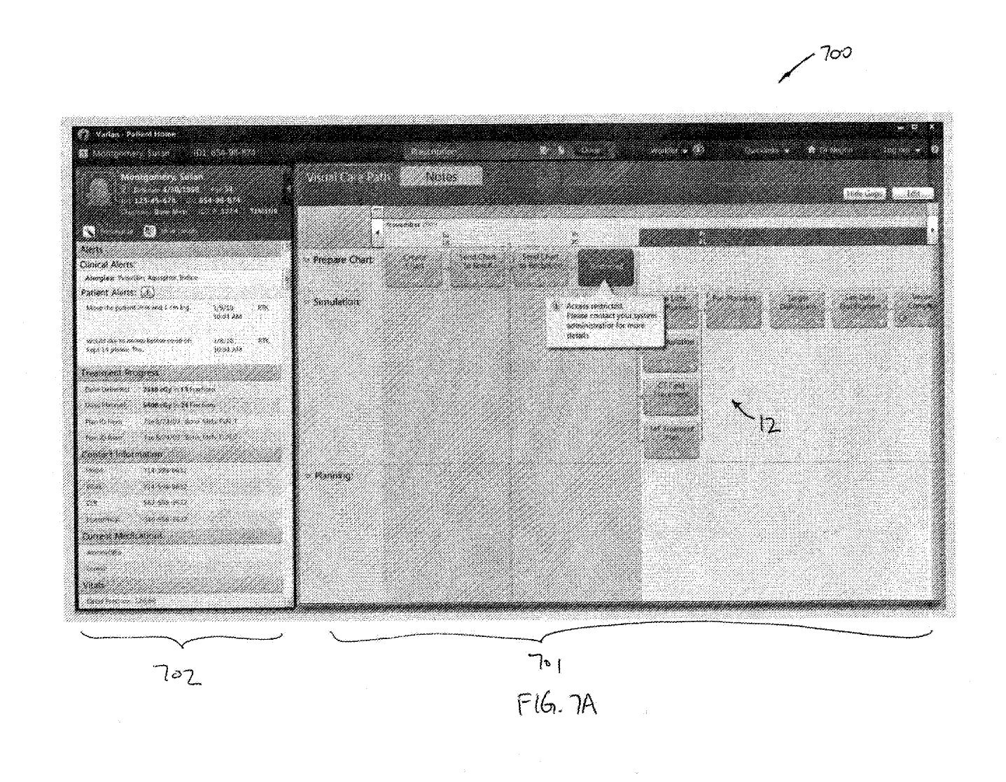

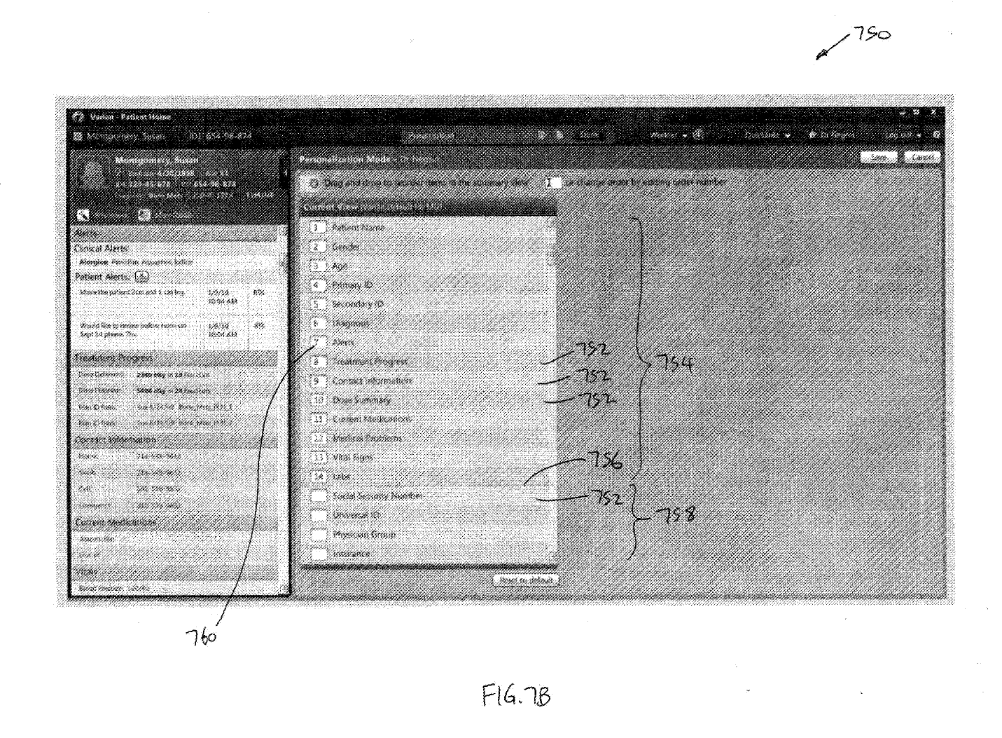

In some embodiments, the user interface 10 may be configured to display a patient summary along with the workflow 12 diagram. FIG. 7A illustrates a window 700 displaying a workflow 12 in accordance with some embodiments. The window 700 may be a variation of the embodiments shown in FIG. 1. In the illustrated embodiments, the window 700 includes a workflow section 701 for displaying the workflow 12, and a patient summary section 702 displaying information regarding the patient. In the workflow section 701, users may use graphic tools to drag and drop individual activities, or templates with multiple activities, into the grid for scheduling events. The patient summary section 702 is a configurable “mini-chart” that displays up-to-date information regarding the patient. Users may view data or with a single click. In other embodiments, instead of a “mini-chart”, the chart may be a complete chart, such as a radiation therapy electronic chart with tabs, for example.

In some embodiments, the user interface 10 may be configured to provide a configuration window that allows users to configure what data they wish to view in the patient summary. FIG. 7B illustrates a configuration window 750 in accordance with some embodiments. The configuration window 750 includes a plurality of items 752 representing different information regarding a patient. In the illustrated example, the items 752 includes patient name, gender, age, primary identification, secondary identification, diagnosis, alerts, treatment progress, contact information, dose summary, current medications, medical problems, vital signs, labs, social security number, universal identification, physician group, and insurance. There may be more items 752 in other embodiments. As shown in the figure, the configuration window 750 also includes a first section 754 above line 756 that includes items 752 selected by the user, and a second section 758 below line 756 that includes items 752 not yet selected by the user. The user may select an item 752 in the second section 758 by dragging the item 752 from the second section 758 to the first section 754, and dropping the item 752 as a desired location in the first section 754. In the illustrated embodiments, each selected items 752 in the first section 754 includes order number 760 representing the order in which the patient information will be displayed under the patient summary. When selecting an item 752, the user may drag and drop the item 752 at a location associated with a desired order in which the user wishes the information to be displayed. For example, if the user wishes the patient summary to include insurance information, and wishes to display such insurance information after the secondary identification, the user may drag and drop the “insurance” item 752 to section 754 between the “Secondary ID” item 752 and the “Diagnosis” item 752.

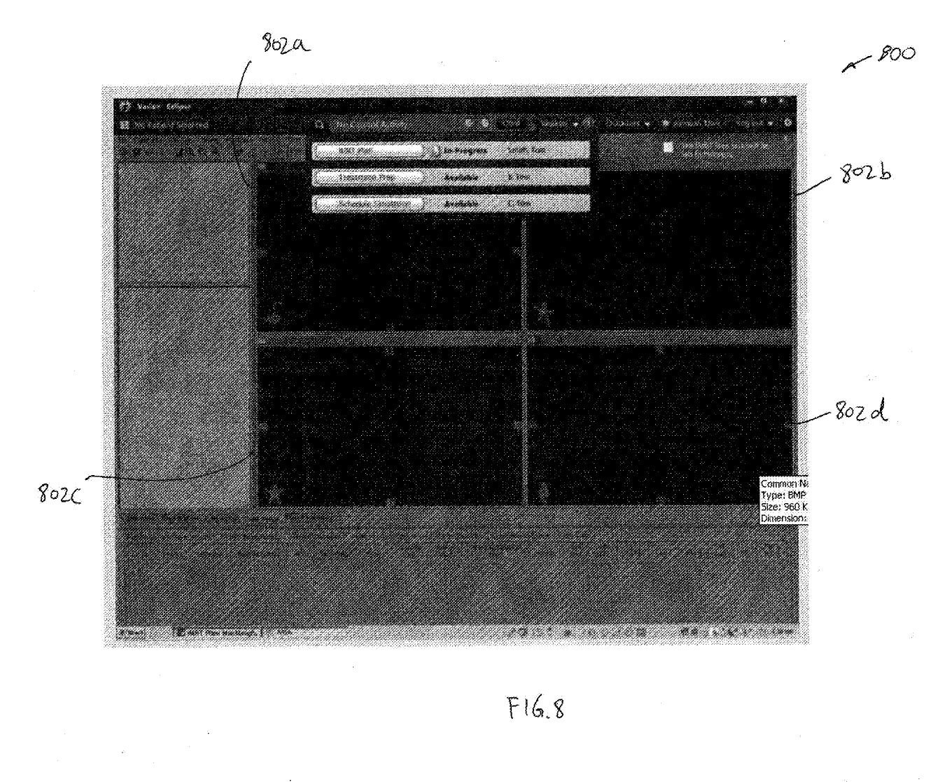

As discussed, embodiments of the user interface 10 allow different workspaces to be linked. In some cases, a user may be able to access multiple workspaces simultaneously. FIG. 8 illustrates another window frame 800 provided by the user interface 10 that allows a user to access multiple workspaces simultaneously. In the illustrated embodiments, the window 800 includes four sections 802a-802d for displaying information for four different respective workspaces. Such feature is advantageous because it allows a user to work on different tasks simultaneously using different respective workspaces. For example, a user who is performing consultation for a patient may open up three workspaces to perform three tasks (e.g., insurance verification, obtaining imaging, obtaining pathology reports). In another example, a user may open up two workspaces to perform two different tasks for two different patients, wherein the two workspaces may be for performing a same type of task (e.g., contouring structure for radiation treatment plan), or for different tasks (e.g., one for contouring structure, and another one for registering CT image with MRI image).

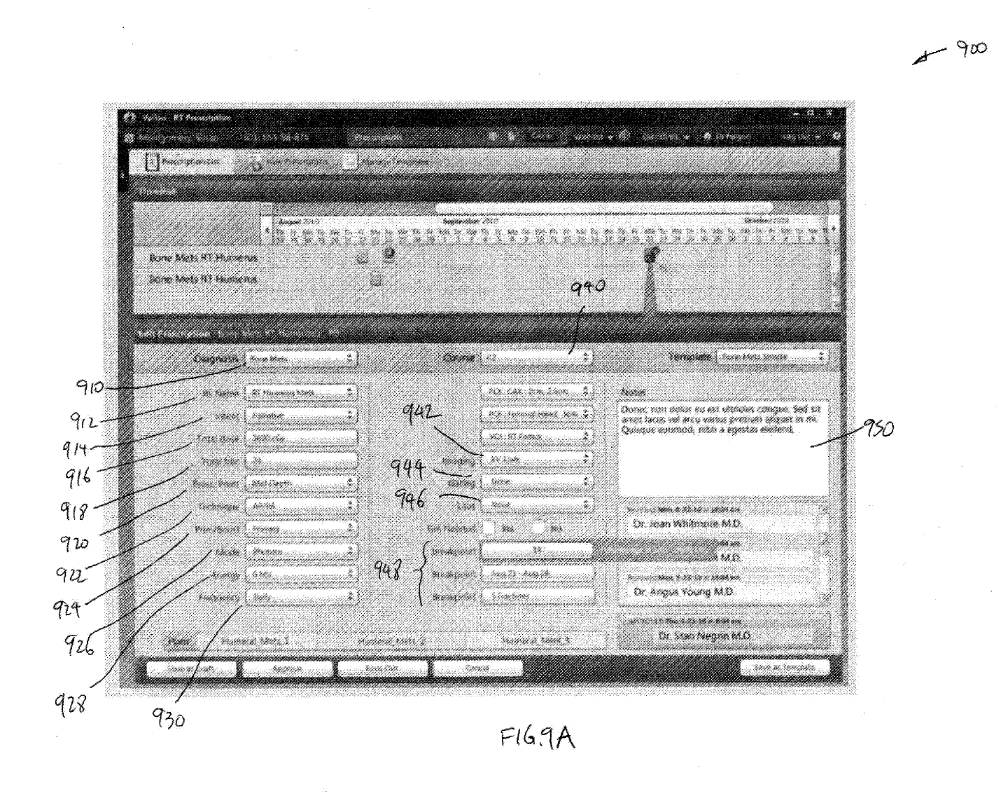

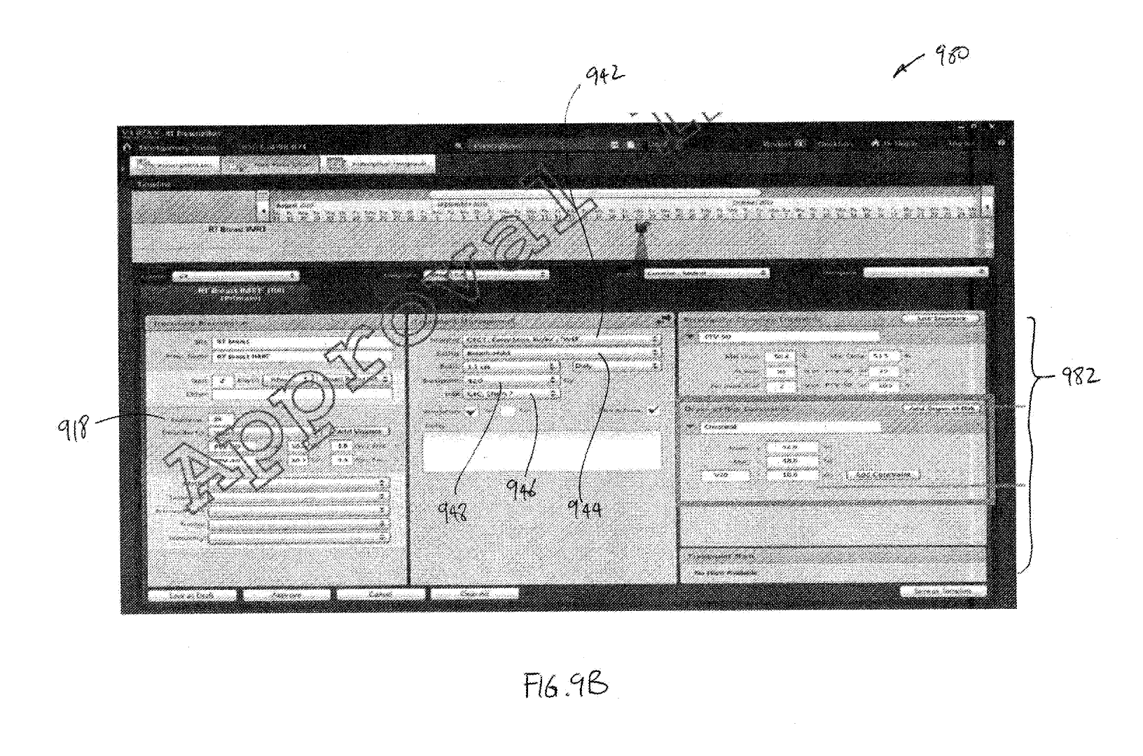

In any of the embodiments described herein, the user interface 10 may also provide a workspace for allowing users to input written directives for delivering radiotherapy. FIG. 9A illustrates a workspace 900 configured for allowing users (e.g., doctors) to input written directives for delivering radiotherapy in accordance with some embodiments. Many of the data elements in the workspace 900 are configurable and prescriptions may be selected from a plurality of pre-determined templates. The “Diagnosis” control 910 is not configurable, but allows users to associate diagnosis to a prescription. In some cases, such association between diagnosis and prescription may be required for documentation purposes. The “Rx Name” field 912 allows a user to enter the name of a prescription. The “Intent” field 914 is for allowing a user to input an intention of a treatment (e.g., to cure, for palliative purposes, etc.). The “Total Dose” field 916 allows a user to enter the total radiation dose that is desired to be delivered to the patient. The “Total frac” field 918 allows users to enter an actual number of treatments to be delivered. The “Presc. Point” 920 allows a user to define how the dose is to be delivered, and to where. In some embodiments, the “Presc. Point” field 920 provides three configurable options for a user: 1) depth (define what depths the dose should be applied), 2) isocenter (a fixed point in space that is placed inside the tumor), 3) Volume (user defines how the dose is to be “painted” across a 3-dimensional volume). The “Technique” field 922 allows a user to prescribe how the radiation beams are to be arranged. There are some standards for delivery of treatment (e.g., 4-fld box, tangents, RapidArc, etc. . . . ), which may be presented as options under the “Technique field” 922 for allowing a user to select from. The “Prim/Boost” field 924 is for allowing a user to input whether the prescription is a primary prescription, or a boost prescription. The “Mode” field 926 allows a user to prescribe what type of radiation is being used (available options are x-rays, gamma, electrons, photons, protons, etc. . . . ). The “Energy” field 928 allows a user to enter an energy level (e.g., how strong is the energy of a radiation beam). The “Frequency” field 930 allows a user to prescribe how often to apply the treatment. The “Course” field 940 allows a user to group treatments to be delivered either concurrently or consecutively. In some embodiments, the grouping may be performed based on a same diagnosis, or different diagnosis. The “Imaging” field 942 allows a user to prescribe how the patient is to be imaged during treatment. In some cases, a user may input those instructions using this field 942. The “Gating” field 944 allows a user to prescribe whether respirator gating is to be used. In some embodiments, the user may select “yes” or “no”, as well as the type of gating to be used. The “Labs” field 946 allows a doctor to prescribe labs to be drawn. In some embodiments, using the “Labs” field 946, users can define which labs to be drawn, and how often to draw those labs. The “Breakpoint” fields 948 allow users to establish a break or stop either based on an achieved dose or by date. The “Notes” field 950 allows users to enter text notes.

In some embodiments, one or more of the fields 910-950 are configurable and scalable to achieve whatever is needed to create a prescription. Different departments may have different machines with different energies and capabilities, and/or may be controlled using different parameters. Users may configure the fields in the window 900 so that they are specific for a certain machine. Different departments may also use different unique terminologies. Thus, in some embodiments, users may configure any of the fields 910-950 so that they display the terminologies that are used in a certain department.

FIG. 9B illustrates another workspace 980 configured for allowing users (e.g., doctors) to input written directives for delivering radiotherapy in accordance with some embodiments. The workspace 980 is similar to the workspace 900 except that it also includes an additional section 982 for allowing a user to enter data about volumetric radiation treatment delivery that the user is trying to capture with the prescription. In the illustrated embodiments, the section 982 includes input fields for allowing a user to prescribe how dose should be spread over a three-dimensional volume, and what the constraints on organs at risk should be. Organs at risk are organs that are not intended to be treated (e.g., irradiated by a radiation beam), but are in the path of the radiation beam. The section 982 is advantageous because it allows the user to define how the dose should cover the volume, and how organs at risk should be limited in the dose they receive.

In any of the embodiments describe herein, the user interface 10 may be implemented using software, hardware (e.g., processor, such as that associated with a computer), or combination of both. For example, in some embodiments, a computer product may be provided that includes instructions stored in a non-transitory medium, wherein an execution of the instructions by a processor causes a process to be performed. The process may involve providing any of the features of the user interface 10 described herein, or any of the features described herein.

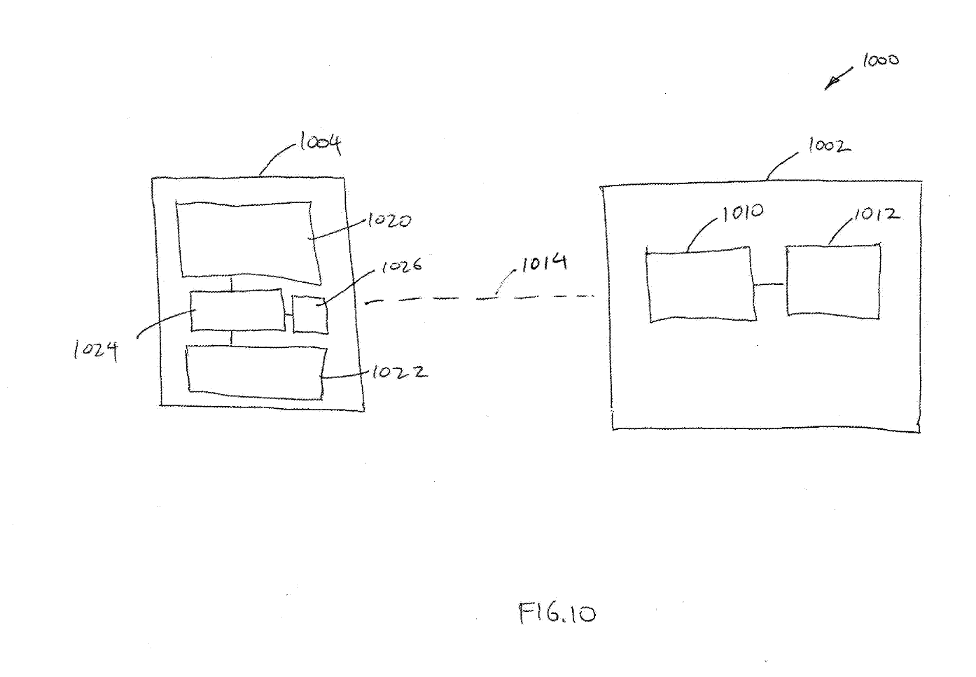

Also, in way of the embodiments described herein, the user interface 10 may be implemented using one or more devices. FIG. 10 illustrates a system 1000 with which embodiments of the user interface 10 may be implemented. The system 1000 includes a database 1002 having a processor 1010 and a non-transitory medium 1012. The database 1002 may be a server, a computer, or any device that includes a processor. The database 1002 is configured to communicate with an end user device 1004 through a network 1014. In some embodiments, the network 1014 may be the Internet. In other embodiments, the network 1014 may be any wireless network, or wired network. Also, in some embodiments, the device 1004 may be considered to be a part of the system 1000. The end user device 1004 includes a screen 1020 (which may be the screen 13 of FIG. 1), an input device 1022 (which may include a keyboard, a rolling ball, a trackpad, a microphone for receiving command, etc.), a processor 1024, and a non-transitory medium 1026. In some embodiments, the input device 1022 may be a touch screen, in which case, the input device 1022 and the screen 1020 may be a same component. The end user device 1004 may be a computer, an iPad, an iPhone, a cell phone, a Blackberry, or any communication device.

In the illustrated embodiments, the medium 1012 of the database 1002 may include a set of instructions, an execution of which by the processor 1010 causes data to be transmitted from the database 1002 to the device 1004. The device 1004 processes the data from the database 1002, and displays graphics on the screen 1020 in response to the processed data. The graphics may be any of the graphics described herein in association with the user interface 10. During use, the user may use the input device 1022 of the device 1004 to enter data. The data may be stored in the medium 1026 and/or be transmitted to the database 1002 via the network 1014.

In one implementation, the device 1004 includes a software that is configured to receive a request by the user to access the database 1002. For example, the software may be configured to be processed by the processor 1024 to provide the user interface 10 for display on the screen 1020. The user interface 10 may provide a field for asking the user to input a user identification, and a password. Upon receiving the user identification and the password, the device 1004 then transmits the information through the network 1014 to the database 1002. The database 1002 includes different users' identifications and corresponding passwords stored in the medium 1012. After receiving the user identification and password from the device 1004, the database 1002 then looks up a table in the medium 1012 to see if the data matches those stored in the medium 1012. If so, then the database 1002 allows the user of the device 1004 to access the database 1002.

In some embodiments, in response to instructions processed by the processor 1024, and/or in response to data received from the database 1002, the device 1004 may display the user interface 10 in the display 1020 for allowing a user to create the workflow 12, edit the workflow 12, and/or to view the workflow 12. If data regarding the workflow 12 (e.g., data regarding the task object(s), link(s) 15, any of the data described herein with reference to FIGS. 1, 3-7A and 9, etc.) are input using the input device 1022, the input data may be stored in the medium 1026, and/or be transmitted to the database 1002 via the network 1014 for storage in the medium 1012. In some cases, another user of a different device 1004 may have access to the data regarding the workflow 12 by accessing the database 1002 through the network 1014. In such cases, the database 1002 may retrieve such data from the medium 1012, and may transmit such data to the device 1004 through the network 1014.

Also, in some embodiments, in response to instructions processed by the processor 1024, and/or in response to data received from the database 1002 through the network 1014, the device 1004 may display different workspaces in the screen 1020 for allowing a user to perform tasks that are represented by different task objects 14 in the workflow 12. For example, the device 1004 may present a workspace for allowing a user to view and/or process images of a patient. In one implementation, the software for presenting the images may be stored in the medium 1026 and/or the medium 1012, and data regarding the images may be retrieved from the medium 1012 of the database 1002, and be transmitted to the device 1004 via the network 1014.

In another example, the device 1004 may present a workspace in the screen 1020 for allowing a user to create contour of structures for radiation treatment planning. In one implementation, the software for presenting the workspace for structure contouring may be stored in the medium 1026 and/or the medium 1012, and the data regarding the contouring may be stored in the medium 1026 and/or be transmitted to the database 1002 for storage in the medium 1012.

In still another example, the device 1004 may present a workspace in the screen 1020 for allowing a user to create a radiation treatment plan. In one implementation, the software for presenting the workspace for treatment planning may be stored in the medium 1026 and/or the medium 1012, and the data regarding the created treatment plan may be stored in the medium 1026 and/or be transmitted to the database 1002 for storage in the medium 1012.

It should be noted that the device 1004 and the database 1002 are not limited to the examples of functions described above, and that the device 1004 and the database 1002 may be configured to provide other functions in other embodiments. For example, in other embodiments, in response to instructions processed by the processor 1024, and/or data received from the database 1002 via the network 1014, the device 1004 may present a workspace in the screen 1020 for allowing any of the functions described in the above table (Table 1). In some embodiments, the different workspaces that may be presented by the device 1004 may be provided by different software. In such cases, different software may be stored in the medium 1012 of the database 1002 and/or the medium 1026 of the device 1004. The database 1002 is configured to associate different task objects 14 with respective workspace(s) provided by the corresponding software. In some cases, a software may provide a plurality of workspaces to perform a plurality of tasks for different task objects 14.

Any of the data associated with a workspace, such as data input by a user of the device 1004 while using the workspace, and data for access by a user of the workspace, may be stored in the medium 1026 of the device 1004 and/or the medium 1012 of the database 1002. Although the medium 1012 of the database 1002 is illustrated as a block, in other embodiments, the medium 1012 of the database 1002 may be implemented using a plurality of storage devices, which may be at a same location, or at different locations (e.g., throughout the world). Also, although only one end user device 1004 is shown, it should be understood that in other embodiments, there may be a plurality of end user devices 1004. The plurality of end user devices 1004 may be configured to perform the same functions, or different functions (e.g., one device 1004 may be configured to provide a first workspace to perform a first task, and another device 1004 may be configured to provide a second workspace different from the first workspace to perform a second task that is different from the first task).

Also, in any of the embodiments described herein, the database 1002 and/or the device 1004 may be configured to provide an interface to a user (e.g., by displaying the interface at the screen of the device 1004), which allows the user to selectively view different data associated with the workflow 12. For example, there may be different controls at the interface, which when selected by the user (e.g., by using the control of the device 1004), will cause a request to be sent to the database 1002 through the network 1014. The database 1002, in response to the received request, will look up data in the medium to retrieve the relevant data, and transmit the retrieved data to the device 1004 through the network 1014 for display on the screen of the device 1004. In some embodiments, the retrieved data may be presented in any of the interface windows of FIGS. 3-9 described herein.

In some embodiments, after the workflow 12 is created, the database 1002 and/or the device 1004 is configured to keep track of the progress of the workflow 12. For example, in some embodiments, the database 1002 and/or the device 1004 is configured to monitor whether a task for a task object 14 has been completed. If the database 1002 and/or the device 1004 determines that a task for a task object 14 is overdue (or is about to be overdue), the database 1002 and/or the device 1004 may inform the owner (the person assigned) of the task and/or the supervisor of the owner of the task. In one implementation, the database 1002 and/or the device 1004 may automatically transmit or display a reminder to the owner or the supervisor, wherein the reminder may be in the form of an email or instant message, for examples. Alternatively, the reminder may be in the form of an escalated task button 480, as described herein. In other embodiments, instead of, or in addition to, providing the reminder, the database 1002 may automatically instruct the device 1004 (e.g., by transmitting instructions to the device 1004 through the network 1014) to, or the device 1004 may automatically, present a workspace on the screen 1020 of the device 1004 for allowing the user to perform the task. Depending on the task that is overdue or that is about to be overdue, the database 1002 and/or the device 1004 may be configured to select the appropriate workspace for presentation on the screen 1020 of the device 1004.

Various techniques may be employed for configuring the database 1002 to monitor progress of a task. In some embodiments, a task for a task object 14 is considered completed when data for certain field of a workspace for performing such task has been entered. In such cases, the database 1002 and/or the device 1004 may be configured to determine if data for certain field of a workspace has been entered. If the database 1002 and/or the device 1004 determines that no data for such field has been entered by the due date, then the database 1002 and/or the device 1004 will determine that the task is overdue. In other embodiments, if the database 1002 and/or the device 1004 determines that no data for such field has been entered within a prescribed number of day(s) (e.g., one day) before the due date, then the database 1002 and/or the device 1004 may determine that the task is about to be overdue, and may send or display a reminder to the owner of the task and/or the supervisor of the owner.

In other embodiments, a task for a task object 14 may be considered completed when a supervisor has signed off on a task object 14. In such cases, the database 1002 and/or the device 1004 may be configured to determine if data for certain field (representing a sign off by the supervisor) of a workspace has been entered. If the database 1002 and/or the device 1004 determines that no data for such field has been entered by the due date, then the database 1002 and/or the device 1004 will determine that the task is overdue. In other embodiments, if the database 1002 and/or the device 1004 determines that no data for such field has been entered within a prescribed number of day(s) (e.g., one day) before the due date, then the database 1002 and/or the device 1004 may determine that the task is about to be overdue, and may provide a reminder to the owner of the task and/or the supervisor of the owner.

In any of the embodiments described herein, the database 1002 and/or the device 1004 may be configured to automatically (without user interaction) advance some actions of the process based on the data states. For example, assume that a workflow 12 includes the following tasks in the following order: (1) Write prescription—(2) approve prescription—(3) create plan. The owner who wrote the prescription to perform the first task may also approved it at the same time to perform the second task. When the database 1002 and/or the device 1004 detects that the “approve prescription” task after the “write prescription” task is already completed, the database 1002 and/or the device 1004 may automatically complete the “approve prescription” task (e.g., by assigning a task state of “complete”), and proceed to the “create plan” task. In the above example, since the person performing the “write prescription” task also approves the prescription at the same time, the “approve prescription” does not involve any user interaction. In other embodiments, if the person performing the “write prescription” task does not approve the prescription at the same time, then the “approve prescription” task may need to be performed separately (either by the same person at a different time, or by another person such as a supervisor). In such cases, the database 1002 and/or the device 1004 does not automatically advance to the “create plan” task, but will wait for a separate user input to complete the “approve prescription” task before advancing to the “create plan” task.

Furthermore, in any of the embodiments described herein, a user may set up one or more rules for the workflow 12 that allows at least a part of the workflow 12 to be automated. In some embodiments, such rules may be created or entered by the user using the input device of the device 1004. In one implementation, when a task object 14 is selected, the device 1004 may provide a user interface for allowing the user to input rule(s) that is associated with the task object 14. Such rule may be “to automatically advance to a next task object when one or more items (e.g., task(s), checklist(s), etc.) associated with the task object 14 is completed.” For example, a user may set up a rule “when a lab result has value greater than X, stop treatment”. In such cases, when the lab result arrives (by electronic feed) at the database 1002, the database 1002 may evaluate the value of the lab result (e.g., by comparing the actual value with the value of the rule). When the database 1002 determines that the rule is satisfied based on the evaluation, then the database 1002 may take certain action(s) based on the rule. For example, the database 1002 may automatically inform a person to stop treatment (such as by sending a message to the device 1004 through the network), automatically flag a treatment plan (such as by retrieving the treatment plan from the medium 1012 of the database 1002, adding a flag to the treatment plan, and storing the treatment plan at the medium 1012), automatically change a treatment plan (such as by retrieving the treatment plan from the medium 1012 of the database 1002, changing one or more parameters in the treatment plan, and storing the treatment plan in the medium 1012), etc. In other embodiments, the database 1002 may also automatically create one or more tasks, change a task state, etc. In other embodiments, instead of creating or inputting the rules using the device 1004, the rules may be created or entered by a user of the database 1002 (e.g., using an input device that is coupled to the database 1002).

In accordance with some embodiments, the system 1000 may be used in a medical process that includes (1) providing a plurality of task objects for selection by a user, wherein the plurality of task objects represent respective tasks, (2) determining a first one of the plurality of task objects that has been selected, (3) determining a second one of the plurality of task objects that has been selected, and (4) linking the first one of the plurality of task objects with the second one of the plurality of task objects based at least in part on a command by the user. In some embodiments, the plurality of task objects may be stored in the medium 1012 of the database 1002 and/or the medium 1026 of the device 1004. The action (1) of providing a plurality of task objects may be performed by the database 1002, which transmits the data representing the task objects to the device 1004 for display on the screen 1020 of the device. In other embodiments, the action (1) of providing the plurality of task objects may be performed by the device 1004, which displays the task objects on the screen 1020.

Also, in some embodiments, the acts (2) (3) of determining first one and second one of the plurality of task objects that have been selected may be performed by the database 1002 by receiving data from the device 1004 indicating selection of the first and second ones of the plurality of task objects. In other embodiments, the acts (2)(2) of determining first and second ones of the plurality of task objects may be performed by the device 1004, which receives an input from a user representing a selection of the first and second ones of the plurality of task objects.

In addition, in some embodiments, the act (4) of linking the first one of the plurality of task objects with the second one of the plurality of task objects may be performed by the database 1002, which stores data representing the linking of the task objects in the medium 1012. The storing of such data may be performed in response to a transmission of such data by the device 1004. In other embodiments, the act (4) of linking the task objects may be performed by the device 1004, which receives an input from the user representing a linking of the first and second task objects.

In some embodiments, when the database 1002 receives data regarding task objects that the user wishes to include as parts of the workflow 12, the database 1002 also receives information associated with the task objects that may be input by the user using the device 1004, wherein such information may be any of the information described with reference to FIGS. 3-4. In some cases, the information associated with a task object may include an identification of an owner of a task that has been assigned to perform the task, as well as identification of a workspace that may be used to perform the task of the task object. After the database 1002 obtains the identification of the owner and the identification of the workspace, the database 1002 then associates the owner information and the workspace information (as well as other information related to the task object) with the task object. Such association is useful when in some cases, the task has become overdue or will become overdue soon. Then the database 1002 may send a reminder to the owner of the task, or to a supervisor of the owner of the task, as described herein. Also, the database 1002 may provide the workspace that is associated with the task object to the device 1004, for allowing the user of the device 1004 to perform the task of the task object, as also described herein.

Computer System Architecture

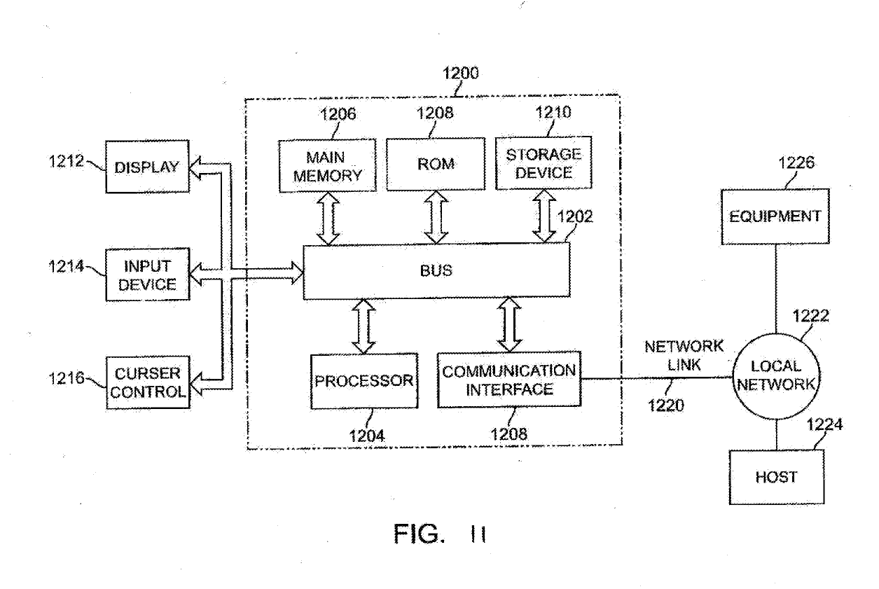

FIG. 11 is a block diagram that illustrates an embodiment of a computer system 1200 upon which embodiments of the features of the user interface 10 may be implemented. In some embodiments, the computer system 1200 may be used to implement the database 1002 or the device 1004 of FIG. 10. Computer system 1200 includes a bus 1202 or other communication mechanism for communicating information, and a processor 1204 coupled with the bus 1202 for processing information. The processor 1204 may be configured to perform various functions described herein. The computer system 1200 also includes a main memory 1206, such as a random access memory (RAM) or other dynamic storage device, coupled to the bus 1202 for storing information and instructions to be executed by the processor 1204. The main memory 1206 also may be used for storing temporary variables or other intermediate information during execution of instructions to be executed by the processor 1204. The computer system 1200 further includes a read only memory (ROM) 1208 or other static storage device coupled to the bus 1202 for storing static information and instructions for the processor 1204. A data storage device 1210, such as a magnetic disk or optical disk, is provided and coupled to the bus 1202 for storing information and instructions.

The computer system 1200 may be coupled via the bus 1202 to a display 1212, such as a cathode ray tube (CRT) or a flat panel, for displaying information to a user. An input device 1214, including alphanumeric and other keys, is coupled to the bus 1202 for communicating information and command selections to processor 1204. Another type of user input device is cursor control 1216, such as a mouse, a trackball, or cursor direction keys for communicating direction information and command selections to processor 1204 and for controlling cursor movement on display 1212. This input device typically has two degrees of freedom in two axes, a first axis (e.g., x) and a second axis (e.g., y), that allows the device to specify positions in a plane.

The computer system 1200 may be used for performing various functions (e.g., calculation) in accordance with the embodiments described herein. According to one embodiment, such use is provided by computer system 1200 in response to processor 1204 executing one or more sequences of one or more instructions contained in the main memory 1206. Such instructions may be read into the main memory 1206 from another computer-readable medium, such as storage device 1210. Execution of the sequences of instructions contained in the main memory 1206 causes the processor 1204 to perform the process steps described herein. One or more processors in a multi-processing arrangement may also be employed to execute the sequences of instructions contained in the main memory 1206. In alternative embodiments, hard-wired circuitry may be used in place of or in combination with software instructions to implement the invention. Thus, embodiments of the invention are not limited to any specific combination of hardware circuitry and software.

The term “computer-readable medium” as used herein refers to any medium that participates in providing instructions to the processor 1204 for execution. Such a medium may take many forms, including but not limited to, non-volatile media, volatile media, and transmission media. Non-volatile media (an example of non-transitory media) includes, for example, optical or magnetic disks, such as the storage device 1210. Volatile media (another example of non-transitory media) includes dynamic memory, such as the main memory 1206. Transmission media includes coaxial cables, copper wire and fiber optics, including the wires that comprise the bus 1202. Transmission media can also take the form of acoustic or light waves, such as those generated during radio wave and infrared data communications.

Common forms of computer-readable media include, for example, a floppy disk, a flexible disk, hard disk, magnetic tape, or any other magnetic medium, a CD-ROM, any other optical medium, punch cards, paper tape, any other physical medium with patterns of holes, a RAM, a PROM, and EPROM, a FLASH-EPROM, any other memory chip or cartridge, a carrier wave as described hereinafter, or any other medium from which a computer can read.

Various forms of computer-readable media may be involved in carrying one or more sequences of one or more instructions to the processor 1204 for execution. For example, the instructions may initially be carried on a magnetic disk of a remote computer. The remote computer can load the instructions into its dynamic memory and send the instructions over a telephone line using a modem. A modem local to the computer system 1200 can receive the data on the telephone line and use an infrared transmitter to convert the data to an infrared signal. An infrared detector coupled to the bus 1202 can receive the data carried in the infrared signal and place the data on the bus 1202. The bus 1202 carries the data to the main memory 1206, from which the processor 1204 retrieves and executes the instructions. The instructions received by the main memory 1206 may optionally be stored on the storage device 1210 either before or after execution by the processor 1204.

The computer system 1200 also includes a communication interface 1218 coupled to the bus 1202. The communication interface 1218 provides a two-way data communication coupling to a network link 1220 that is connected to a local network 1222. For example, the communication interface 1218 may be an integrated services digital network (ISDN) card or a modem to provide a data communication connection to a corresponding type of telephone line. As another example, the communication interface 1218 may be a local area network (LAN) card to provide a data communication connection to a compatible LAN. Wireless links may also be implemented. In any such implementation, the communication interface 1218 sends and receives electrical, electromagnetic or optical signals that carry data streams representing various types of information.

The network link 1220 typically provides data communication through one or more networks to other devices. For example, the network link 1220 may provide a connection through local network 1222 to a host computer 1224 or to equipment 1226 such as a radiation beam source or a switch operatively coupled to a radiation beam source. The data streams transported over the network link 1220 can comprise electrical, electromagnetic or optical signals. The signals through the various networks and the signals on the network link 1220 and through the communication interface 1218, which carry data to and from the computer system 1200, are exemplary forms of carrier waves transporting the information. The computer system 1200 can send messages and receive data, including program code, through the network(s), the network link 1220, and the communication interface 1218.

Although particular embodiments have been shown and described, it will be understood that they are not intended to limit the present inventions, and it will be obvious to those skilled in the art that various changes and modifications may be made without departing from the spirit and scope of the present inventions. The specification and drawings are, accordingly, to be regarded in an illustrative rather than restrictive sense. The present inventions are intended to cover alternatives, modifications, and equivalents, which may be included within the spirit and scope of the present inventions as defined by the claims.

What is claimed:

1. A method for use in a medical process, comprising:
providing a plurality of task objects for selection by a user, wherein the plurality of task objects represent respective tasks;
determining a first one of the plurality of task objects;
determining a second one of the plurality of task objects;
linking the first one of the plurality of task objects with the second one of the plurality of task objects using a processor based at least in part on a command by the user; and
storing data in a non-transitory medium regarding the linking.

2. The method of claim 1, further comprising displaying a graphic on a screen to illustrate the first one of the plurality of task objects, the second one of the plurality of task objects, and the linking of the first one of the plurality of task objects with the second one of the plurality of task objects.

3. The method of claim 2, wherein the screen comprises an iphone screen, a computer screen, an ipad screen, or a screen of a handheld device.

4. The method of claim 2, further comprising displaying a calendar on the screen, wherein the first one of the plurality of task objects corresponds with a first date on the calendar, and the second one of the plurality of task objects corresponds with a second date on the calendar.

5. The method of claim 1, wherein the act of providing the plurality of task objects comprises providing a user interface, and wherein the user interface is configured to allow the user to create a workflow by the act of linking, delete the workflow, or modify the workflow.

6. The method of claim 1, wherein one of the tasks involves a diagnostic procedure to diagnose a cancerous condition, and another one of the tasks involves a treatment procedure to treat the cancerous condition.

7. The method of claim 6, wherein the diagnostic procedure comprises a radiation imaging procedure.

8. The method of claim 6, wherein the treatment procedure comprises a radiation treatment procedure.

9. The method of claim 1, further comprising associating a person's name and a due date for the first one of the plurality of task objects.

10. The method of claim 9, further comprising informing the person, or a supervisor of the person, of the due date for completing the task that is represented by the first one of the plurality of task objects.

11. The method of claim 1, further comprising:
determining a third one of the plurality of task objects; and
linking the third one of the plurality of task objects with the second one of the plurality of task objects;
wherein the acts of linking create a workflow in which the task represented by the first one of the plurality of task objects and the task represented by the third one of the plurality of task objects are prescribed to be performed in parallel, and to be completed before the task represented by the second one of the plurality of task objects is started.

12. The method of claim 1, further comprising:
associating the first one of the plurality of task objects with a first workspace; and
associating the second one of the plurality of task objects with a second workspace.

13. The method of claim 12, wherein the first workspace comprises a first software, and the second workspace comprises a second software that is separate from the first software.

14. The method of claim 1, wherein the first one of the plurality of task objects comprises a checklist associated therewith, and the method further comprises determining whether the checklist is completed, wherein the act of determining whether the checklist is completed is performed by the processor.

15. The method of claim 1, wherein the first one of the plurality of task objects and the second one of the plurality of task objects are parts of a pre-determined template that represents a workflow in which the first one of the plurality of task objects and the second one of the plurality of task objects are linked; and
wherein the acts of determining the first one and the second one of the plurality of task objects, and the act of linking, are performed by the processor that receives the template.

16. The method of claim 1, further comprising automatically advancing from the first one of the plurality of task objects to the second one of the plurality of task objects using the processor when the first one of the plurality of task objects is completed.

17. The method of claim 1, further comprising automatically sending out a reminder using the processor when the task represented by the first one of the plurality of task objects is overdue or is within a prescribed period from being overdue.

18. The method of claim 1, further comprising, after the act of linking, providing a workspace for allowing the task represented by the first one of the plurality of task objects to be completed, wherein the workspace is provided when the first one of the plurality of task objects is selected.

19. The method of claim 1, wherein the task represented by the first one of the plurality of task objects comprises one of: Atlas based segmentation, Define target, Define plan, Calculate plan, Define organs, Register images—rigid registration, Review positioning images, Review Portal Dosimetry Results, Define imaging and positioning parameters for a plan, Schedule plan or images, Review and approve dose distribution, Compare plans, Treatment approve plan, Review RT treatment history, Record manual Treatment, Perform dose correction, Check patient chart, Edit and review patient diagnosis, Register patient, Enter demographics, Enter or verify insurance, Enter or edit medical history, Enter or edit patient evaluation data, Schedule activity or resources, Define or edit Care Path for a patient, Enter and review reference points, Review vitals, Prescribe treatment, Define brachytherapy plan, Calculate brachytherapy plan, Sum and subtract plans, Review plans, Localize stereotactic frame, Define cone plan, Calculate dose for cone plan, Review dose distribution—cone planning, Import images, Import treatment records, Run report, Import plan, Export images, Export treatment records, Export plan, Review or edit charges, Approve charges, View archive data, Review test results, Create or edit document, Create or edit dynamic document, Review or approve document, Perform simulation, Acquire simulation CBCT, Perform virtual simulation, Edit 3D plan parameters, Edit 2D plan parameters, Edit brachytherapy plan, Optimize brachytherapy plan, Review and approve structures, Review image registration results, Review partial treatment, Browse patient Images, Import patient demographics, Review patient journal, Export patient demographics, Complete questionnaire, Perform consult, Order labs/studies, Review or approve 2D plan, Optimize or re-optimize external plan, Review or approve Structures, Approve physician order, Transcribe physician order, Create physician order, Enter/edit/approve drug order, Review activities, Review referrals, Create office visit summary, Review current medications, Provide health information to patient, Register images—deformable registration, Review brachytherapy plans, Create brachytherapy documentation, Export to treatment unit, Define Acuity brachytherapy plan, Review patient images and make decision, Define 3D brachytherapy plan using existing plan, Review and approve brachytherapy Dose Distribution, Define 2D brachytherapy plan, Weekly chart QA, Send Reminder, Define and Calculate 2D Plan, Review Editing Log, acquire patient position for radiation treatment, register patient position for radiation treatment, perform radiation treatment simulation, and perform radiation treatment.

20. A computer product comprising a non-transitory medium for storing a set of instructions, an execution of which causes a process to be performed, the process comprising:
providing a plurality of task objects for selection by a user, wherein the plurality of task objects represent respective tasks;
determining a first one of the plurality of task objects;
determining a second one of the plurality of task objects; and
linking the first one of the plurality of task objects with the second one of the plurality of task objects based at least in part on a command by the user.

21. The computer product of claim 20, wherein the process further comprises displaying a graphic on a screen to illustrate the first one of the plurality of task objects, the second one of the plurality of task objects, and the linking of the first one of the plurality of task objects with the second one of the plurality of task objects.

22. The computer product of claim 21, wherein the screen comprises an iphone screen, a computer screen, an ipad screen, or a screen of a handheld device.

23. The computer product of claim 21, wherein the process further comprises displaying a calendar on the screen, wherein the first one of the plurality of task objects corresponds with a first date on the calendar, and the second one of the plurality of task objects corresponds with a second date on the calendar.

24. The computer product of claim 20, wherein the act of providing the plurality of task objects comprises providing a user interface, and wherein the user interface is configured to allow the user to create a workflow by the act of linking, delete the workflow, or modify the workflow.

25. The computer product of claim 20, wherein one of the tasks involves a diagnostic procedure to diagnose a cancerous condition, and another one of the tasks involves a treatment procedure to treat the cancerous condition.

26. The computer product of claim 25, wherein the diagnostic procedure comprises a radiation imaging procedure.

27. The computer product of claim 25, wherein the treatment procedure comprises a radiation treatment procedure.

28. The computer product of claim 20, wherein the process further comprises associating a person's name and a due date for the first one of the plurality of task objects.

29. The computer product of claim 28, wherein the process further comprises informing the person, or a supervisor of the person, of the due date for completing the task that is represented by the first one of the plurality of task objects.

30. The computer product of claim 20, further comprising:
determining a third one of the plurality of task objects; and
linking the third one of the plurality of task objects with the second one of the plurality of task objects;
wherein the acts of linking create a workflow in which the task represented by the first one of the plurality of task objects and the task represented by the third one of the plurality of task objects are prescribed to be performed in parallel, and to be completed before the task represented by the second one of the plurality of task objects is started.

31. The computer product of claim 20, further comprising:
associating the first one of the plurality of task objects with a first workspace; and
associating the second one of the plurality of task objects with a second workspace.

32. The computer product of claim 31, wherein the first workspace comprises a first software, and the second workspace comprises a second software that is separate from the first software.

33. The computer product of claim 20, wherein the first one of the plurality of task objects comprises a checklist associated therewith, and the process further comprises determining whether the checklist is completed.

34. The computer product of claim 20, wherein the first one of the plurality of task objects and the second one of the plurality of task objects are parts of a pre-determined template that represents a workflow in which the first one of the plurality of task objects and the second one of the plurality of task objects are linked; and
wherein the acts of determining the first one and the second one of the plurality of task objects, and the act of linking, are performed by a processor that receives the template.

35. The computer product of claim 20, wherein the process further comprises automatically advancing from the first one of the plurality of task objects to the second one of the plurality of task objects when the first one of the plurality of task objects is completed.

36. The computer product of claim 20, wherein the process further comprises automatically sending out a reminder when the task represented by the first one of the plurality of task objects is overdue or is within a prescribed period from being overdue.

37. The computer product of claim 20, wherein the process further comprises, after the act of linking, providing a workspace for allowing the task represented by the first one of the plurality of task objects to be completed, wherein the workspace is provided when the first one of the plurality of task objects is selected.

38. The computer product of claim 20, wherein the task represented by the first one of the plurality of task objects comprises one of: Atlas based segmentation, Define target, Define plan, Calculate plan, Define organs, Register images—rigid registration, Review positioning images, Review Portal Dosimetry Results, Define imaging and positioning parameters for a plan, Schedule plan or images, Review and approve dose distribution, Compare plans, Treatment approve plan, Review RT treatment history, Record manual Treatment, Perform dose correction, Check patient chart, Edit and review patient diagnosis, Register patient, Enter demographics, Enter or verify insurance, Enter or edit medical history, Enter or edit patient evaluation data, Schedule activity or resources, Define or edit Care Path for a patient, Enter and review reference points, Review vitals, Prescribe treatment, Define brachytherapy plan, Calculate brachytherapy plan, Sum and subtract plans, Review plans, Localize stereotactic frame, Define cone plan, Calculate dose for cone plan, Review dose distribution—cone planning, Import images, Import treatment records, Run report, Import plan, Export images, Export treatment records, Export plan, Review or edit charges, Approve charges, View archive data, Review test results, Create or edit document, Create or edit dynamic document, Review or approve document, Perform simulation, Acquire simulation CBCT, Perform virtual simulation, Edit 3D plan parameters, Edit 2D plan parameters, Edit brachytherapy plan, Optimize brachytherapy plan, Review and approve structures, Review image registration results, Review partial treatment, Browse patient Images, Import patient demographics, Review patient journal, Export patient demographics, Complete questionnaire, Perform consult, Order labs/studies, Review or approve 2D plan, Optimize or re-optimize external plan, Review or approve Structures, Approve physician order, Transcribe physician order, Create physician order, Enter/edit/approve drug order, Review activities, Review referrals, Create office visit summary, Review current medications, Provide health information to patient, Register images—deformable registration, Review brachytherapy plans, Create brachytherapy documentation, Export to treatment unit, Define Acuity brachytherapy plan, Review patient images and make decision, Define 3D brachytherapy plan using existing plan, Review and approve brachytherapy Dose Distribution, Define 2D brachytherapy plan, Weekly chart QA, Send Reminder, Define and Calculate 2D Plan, Review Editing Log, acquire patient position for radiation treatment, register patient position for radiation treatment, perform radiation treatment simulation, and perform radiation treatment.

39. A system for use in a medical process, comprising:
a processor configured for:
providing a plurality of task objects for selection by a user, wherein the plurality of task objects represent respective tasks,
determining a first one of the plurality of task objects,
determining a second one of the plurality of task objects, and
linking the first one of the plurality of task objects with the second one of the plurality of task objects based at least in part on a command by the user.
